(19) United States
(12) Patent Application Publication
(10) Pub. No.: US 2026/0368502 A1
(43) Pub. Date: Nov. 19, 2026

(54) AI RESPONSE GOVERNANCE SYSTEM WITH QUALITY-GATED CONTENT SUBSTITUTION

(71) Applicant: Woojin Kim, Seoul (KR)

(72) Inventor: Woojin Kim, Seoul (KR)

(21) Appl. No.: 19/707,303

(22) Filed: Jun. 14, 2026

Related U.S. Application Data
(63) Continuation of application No. 19/694,903, filed on Jun. 1, 2026.
Application No. 19/694,903 is a continuation of application No. PCT/KR2025/020677, filed on Dec. 4, 2025.

(30) Foreign Application Priority Data
May 14, 2025 (KR) 10-2025-0062375

(51) Int. Cl. G06N 3/0475

(52) U.S. Cl. CPC G06N 3/0475

(57) ABSTRACT

An artificial intelligence response governance system receives a user query and generates a response output using a generative AI model. The system identifies semantic blocks included in or derived from the response output and performs response-level evaluation to determine whether a response quality condition is satisfied. When the condition is not satisfied, the system performs block-level evaluation to select one or more semantic blocks for controlled use, non-use, replacement, or reconstruction. A corresponding portion of a final user-facing output may be formed using pre-validated verified static content. The system may classify an output purpose and apply a corresponding output template to integrate semantic blocks and verified static content through inline insertion, reference-based connection, or separate-section presentation. Internal feedback generated based on verified static content may adjust a content-expression balance control value through a nonlinear self-regulation mechanism for subsequent response processing.

### CROSS-REFERENCE TO RELATED APPLICATIONS

This application is a continuation of U.S. patent application Ser. No. 19/694,903, filed on Jun. 1, 2026, which is a continuation of International Application No. PCT/KR2025/020677, filed on Dec. 4, 2025, which claims priority to Korean Patent Application No. 10-2025-0062375, filed on May 14, 2025, the entire disclosures of each of which are incorporated herein by reference.

### TECHNICAL FIELD

The present disclosure relates to artificial intelligence (AI)-based response systems and generative AI output-governance systems. More particularly, the present disclosure relates to systems and methods for integrating verified static content with dynamically generated responses, controlling formation of final user-facing outputs, generating structured outputs, and adaptively adjusting response processing operations.

In some embodiments, such adaptive adjustment may support autonomous optimization under a condition in which user intervention or external user feedback is unavailable, delayed, sparse, unreliable, or otherwise insufficient for continuous response-quality improvement (hereinafter, a “feedback-limited condition”).

### BACKGROUND

Artificial intelligence-based natural language response systems are increasingly used to generate responses to user queries in a variety of technical and professional domains. Although such systems may provide rapid and flexible responses, they may also face challenges in maintaining factual reliability, structural consistency, and domain-appropriate presentation across different use environments.

One challenge relates to the reliability of dynamically generated content. In some cases, a generated response may include factually incorrect or unsupported information while still appearing linguistically plausible. This phenomenon is often referred to as hallucination. The risk associated with such output may be particularly significant in domains such as medicine, law, finance, engineering, and other fields in which response accuracy and reliability are important.

Another challenge relates to structural alignment between a generated response and the presentation requirements of a particular domain or output purpose. Different domains may require different response structures, terminology, levels of detail, and forms of explanation.

For example, medical information may require careful preservation of factual accuracy, educational content may require a balance between accuracy and understandability, and legal content may require precise use of specialized terminology and structured reasoning. Conventional response systems may not adequately adapt the structure and expression of a response to such domain-specific requirements.

A further challenge relates to the use of verified information. Even when reliable static information, such as expert-reviewed text, tables, formulas, charts, guidelines, or reference materials, is available, conventional systems may not provide a systematic mechanism for semantically aligning such verified information with dynamically generated response content. As a result, verified information may be presented separately, merely cited, or insufficiently integrated with the generated response, thereby reducing coherence, reliability, and practical usability of the final output.

Still another challenge relates to response improvement mechanisms. Many conventional systems rely on external evaluation, user feedback, or post-response correction to improve output quality. In environments where user feedback is unavailable, delayed, sparse, or unreliable, such systems may have difficulty continuously improving response quality or adapting response characteristics in real time. This limitation may be significant in applications requiring consistent response quality without continuous human intervention.

In addition, conventional systems may provide substantially uniform responses to users having different levels of expertise, different preferred depths of explanation, or different expression preferences. Although a user query itself may include immediate requirements, such as a request for a simple explanation, a professional-level explanation, a summary, or a comparative analysis, conventional systems may not consistently reflect such query-specific requirements in a structured and systematic manner.

Certain systems may retrieve reference information or filter generated outputs, but may not provide semantic-block-level substitution in which response-level evaluation and semantic-block-level selection operate at different control levels.

Accordingly, there remains a need for an AI response system that can integrate dynamically generated responses with verified static content, evaluate response content at a semantic-block level, structure an output according to output purpose and domain characteristics, and support autonomous response quality improvement based on internal feedback.

### BRIEF SUMMARY OF THE INVENTION

In some embodiments, an artificial intelligence response governance system is provided. The system may receive a user query, generate a response output using a generative artificial intelligence model, identify one or more semantic blocks included in or derived from the response output, evaluate information accuracy for one or more semantic blocks, and form a final user-facing output by integrating dynamically generated response content with pre-validated verified static content.

In some embodiments, the system may calculate a response quality indicator for the generated response output and determine whether at least a portion of the response output requires substitution or alternative processing. The determination may be based on the response quality indicator, information accuracy associated with one or more semantic blocks, output purpose, domain characteristics, content relevance, or a combination thereof.

In some embodiments, the response quality indicator may be used as a response-level criterion for determining whether to activate an alternative processing mode for the response output. After the alternative processing mode is activated, a block-level evaluation value associated with one or more semantic blocks may be used to select at least one semantic block for replacement, preservation, rearrangement, reconstruction, omission, exclusion, or non-use in forming the final user-facing output.

In some embodiments, a semantic block selected for replacement may be omitted from, excluded from, or not used in forming the final user-facing output, and a corresponding portion of the final user-facing output may be formed using pre-validated verified static content.

In some embodiments, the system may classify an output purpose of the response and select or adjust an output template corresponding to the classified output purpose. The system may arrange semantic blocks according to the selected or adjusted output template and may determine a manner of connecting verified static content to the semantic blocks, including inline insertion, reference-based connection, or separate-section presentation.

In some embodiments, the system may calculate a comprehensive evaluation index for each semantic block based on information accuracy and expression style. The comprehensive evaluation index may be used as a decision criterion for block placement, verified static content connection, content integration, and alternative processing. The system may also use a content-expression balance control value to regulate a balance between information accuracy and expression style.

In some embodiments, internal feedback may be generated based on verified static content and used to support autonomous response quality improvement under a feedback-limited condition.

In some embodiments, information generated during response quality verification, internal feedback generation, alternative processing, output structuring, or final-output formation may be stored, maintained, or referenced as governance reference information for subsequent response processing.

Such governance reference information may include verified static content, response evaluation information, internal feedback information, information indicating an alternative processing operation, information indicating a response control condition, information associated with a previously generated response output, information associated with a previously formed final user-facing output, or a combination thereof.

In some embodiments, the system may generate internal governance feedback based on the governance reference information and may dynamically adjust a response-governance control parameter using a nonlinear self-regulation mechanism.

The response-governance control parameter may affect at least one subsequent response processing operation, including calculation of a block-level evaluation value, selection of verified static content, determination of a verified static content connection method, activation of alternative processing, determination of a response-control state, determination of whether generated response content is used in forming a final user-facing output, response reconstruction, or final user-facing output formation.

In some embodiments, the nonlinear self-regulation mechanism may provide an adjustment magnitude that is greater within a target operating range than near one or more boundary values of an allowable control range. Such nonlinear adjustment behavior may reduce over-correction or oscillation of the response-governance control parameter across successive response processing cycles while allowing more active adaptation within the target operating range.

In some embodiments, the final user-facing output may include metadata, source information, labels, traceability information, or other output artifacts associated with use of verified static content, alternative processing, response-control state determination, omission or non-use of generated response content, substitution, reconstruction, or another output-governance operation. In some embodiments, the disclosed system may provide specific technological improvements to operation of a generative artificial intelligence response system.

For example, the system may reduce repeated full-response regeneration when only a portion of a response output is deficient by performing block-level remediation after a response-level quality decision. The system may also support continuous response-quality improvement under a feedback-limited condition by generating internal feedback based on verified static content. In some embodiments, the nonlinear self-regulation mechanism may reduce over-correction or oscillation in feedback-based adjustment of a response-governance control parameter or content-expression balance control value.

In some embodiments, structural separation between response-level evaluation and block-level selection may enable more targeted control of generated response content in forming a final user-facing output. Such operations may be implemented by specific system components, including a Response Quality Verification Unit, an Alternative Processor, an Adaptive Optimization Unit, and a Verified Static Content Repository, as described herein.

These improvements may address technical limitations of conventional generative artificial intelligence response systems, including computational inefficiency arising from full-response regeneration, reduced reliability under sparse-feedback operation, and instability of feedback-based parameter adjustment using linear update methods.

The improvements described above are technical improvements rooted in computer technology and artificial intelligence response systems. In some embodiments, the structural separation between response-level evaluation and block-level selection, the integration of pre-validated verified static content with dynamically generated response content, and the nonlinear self-regulation mechanism for adjusting a response control parameter may address technical problems arising in generative artificial intelligence response systems. Such technical problems may include inefficient full-response regeneration, unstable feedback-based adjustment, and unreliable output formation under feedback-limited conditions. These improvements may be implemented through specific system components, including the Response Quality Verification Unit, the Alternative Processor, the Adaptive Optimization Unit, the Content Matching Unit, and the Verified Static Content Repository, as described herein. In some embodiments, the technical operations described herein may produce a tangible final user-facing output that integrates dynamically generated response content with pre-validated verified static content.

### BRIEF DESCRIPTION OF THE DRAWINGS

FIG. 1 illustrates an overall system configuration of the disclosed system.

FIG. 2 illustrates a process for generating a style vector and a query customization adjustment value in a user query input unit.

FIG. 3 illustrates an internal configuration of a response semantic analysis unit and a method for calculating information accuracy.

FIG. 4 illustrates a process in which an output purpose determination unit performs output purpose classification and template recommendation.

FIG. 5 illustrates a verified static content recommendation and insertion process performed by a content matching unit.

FIG. 6 illustrates a process in which an adaptive optimization unit applies a query customization adjustment value and executes a self-regulation mechanism.

FIG. 7 illustrates semantic block structuring and verified static content integration performed by an output structuring unit.

FIG. 8 illustrates quality evaluation and final output handling performed by a response quality verification unit and an output provision unit.

FIG. 9 illustrates structural connections among modules in a common service layer.

FIG. 10 illustrates a flow of an information accuracy calculation algorithm.

FIG. 11 illustrates a dynamic adjustment algorithm for a content-expression balance control value.

FIG. 12 illustrates learning behavior of a nonlinear self-regulation mechanism.

FIG. 13 illustrates a process for determining a method for linking verified static content based on content relevance and evaluation indices.

FIG. 14 illustrates combined operation of query-specific customization and autonomous optimization in a medical-domain use case.

In the accompanying drawings, Greek letters are represented by corresponding English letters, where L represents λ (lambda), a/b/g represent α/β/γ respectively, eta represents η, phi represents φ, and eps represents ε.

### DETAILED DESCRIPTION

### System Overview

The present disclosure relates to a system and method for governing outputs of a generative artificial intelligence system by integrating dynamically generated response content with verified static content. In some embodiments, the disclosed system and method may govern artificial intelligence response outputs generated by a generative artificial intelligence model.

In some implementations, the system addresses limitations that may arise in conventional AI response systems, including dependency on continuous external intervention for quality improvement, insufficient mechanisms for structuring and delivering reliable information, and uniform response generation approaches that may not adequately reflect domain-specific characteristics or individual query requirements.

To address such limitations, the system may operate through four integrated processes.

First, a query customization process may detect expression preferences or response requirements from a user query in real time and reflect them in response structuring, response processing, and final user-facing output formation.

Second, an autonomous optimization process may improve response quality by using verified static content as an internal evaluation criterion under a feedback-limited condition.

Third, an output structuring process may structure generated response content and verified static content according to user intent, output purpose, and domain characteristics.

Fourth, multi-level alternative processing may provide tiered response handling when a response quality condition is not satisfied.

In some embodiments, these processes may operate using a comprehensive evaluation index (I(v)) and a content-expression balance control value (λ) as common control criteria. Through this configuration, the system may support autonomous response quality improvement and query-specific response adaptation.

### Definitions

To facilitate understanding of the present disclosure, several terms and concepts are described below. These definitions are provided for explanatory purposes and are not intended to limit the scope of the claims unless expressly recited in the claims.

A “style vector” refers to a multi-dimensional numerical vector extracted from a user query. In some embodiments, the style vector may represent query intent, stylistic characteristics, response-depth requirement, expected response tone, domain characteristic, output-purpose characteristic, or a combination thereof. The style vector may be used for template selection, output purpose determination, or query-specific response structuring.

In certain embodiments, the style vector may be implemented as a three-dimensional numerical vector, for example using intent, style, and response depth as primary components, while other query-level characteristics may be represented as metadata, auxiliary vector components, or classification labels associated with the style vector.

A “query customization adjustment value” refers to an adjustment value for a content-expression balance control value, which may be determined based on characteristics of a user query. In some embodiments, the query customization adjustment value may reflect an expression requirement, an information-depth requirement, an output-purpose requirement, or another query-specific requirement included in the user query. In some embodiments, the query customization adjustment value may correspond to, or may also be referred to as, a query-specific adjustment value.

A “semantic block” refers to a structuring unit included in, identified from, or derived from an AI-generated response. In some embodiments, the semantic block may correspond to a sentence, a group of consecutive sentences, a clause, a paragraph, or another semantically meaningful response unit. Each semantic block may serve as a reference unit for information accuracy evaluation, content relevance calculation, template placement, verified static content connection, or alternative processing. “Information accuracy” or “C(v)” refers to a block-level indicator representing reliability, importance, factual suitability, or information-accuracy-supporting characteristics of information included in a semantic block v. In some embodiments, the information accuracy may be represented on a normalized scale and may be calculated based on one or more of intrinsic significance, contextual connectivity, and output purpose fitness.

In some embodiments, C(v) may be used together with content relevance, verified static content matching, internal feedback, response quality verification, or alternative processing, and need not alone constitute a final determination of factual truth of every statement in the semantic block. Rather, C(v) may serve as a block-level evaluation value that supports selection, preservation, replacement, arrangement, or verified static content integration within the overall response-governance process. “Verified static content” or “verified content” refers to static information whose reliability has been pre-reviewed, pre-approved, curated, or otherwise verified before being used by the system. The verified static content may include text, tables, formulas, charts, images, guidelines, reference materials, or other information. In some embodiments, verified static content may be used as replacement content, supplementary content, a reference basis for evaluating response quality, or a reference basis for generating internal feedback.

In some embodiments, verified static content may also be referred to as pre-validated verified static content.

“Content relevance” or “CR” refers to an indicator representing a semantic relationship between a semantic block and verified static content. In some embodiments, content relevance may be determined based on keyword similarity, semantic proximity, domain relevance, output purpose relevance, or a combination thereof. Content relevance may be used to determine whether and how verified static content is connected to a semantic block.

An “output template” refers to an output framework structured according to an output purpose. In some embodiments, output templates may include explanatory, summary, comparative, guidance, or other response types. An output template may include one or more slots, ordering rules, block capacity conditions, required information accuracy conditions, or format constraints.

A “final user-facing output” refers to an output provided, or prepared to be provided, to a user after response processing, output structuring, alternative processing, verified static content integration, omission, exclusion, non-use, substitution, reconstruction, formatting, or another output-governance operation. In some embodiments, the final user-facing output may include generated response content, pre-validated verified static content, structured content, metadata, source information, labels, traceability information, or a combination thereof.

A “comprehensive evaluation index” or “I(v)” refers to a block-level evaluation value associated with a semantic block v. In some embodiments, the comprehensive evaluation index may be determined based on information accuracy and expression style. The comprehensive evaluation index may be used as a decision criterion for content connection, block placement, block priority determination, content integration, or alternative processing.

A “content-expression balance control value” or “λ” refers to a control value for regulating a balance between information accuracy and expression style. In some embodiments, the content-expression balance control value may be set based on a domain, output purpose, query-specific characteristic, internal feedback, external feedback, or a combination thereof.

A “content mapping table” refers to data representing connection information between one or more semantic blocks and one or more pieces of verified static content. In some embodiments, the content mapping table may include connection methods, including inline insertion, reference-based connection, or separate-section presentation, insertion positions, connection priorities, content relevance values, or other mapping information. The content mapping table may be used by an output structuring unit to integrate verified static content with a generated response.

“Internal feedback” refers to feedback generated by the system based on verified static content or a response output including verified static content. In some embodiments, internal feedback may be generated and used to adjust a response control parameter.

“External feedback” or “user feedback” refers to evaluation information collected from outside the system. In some embodiments, external feedback may include explicit user evaluations, implicit user behavior data, correction inputs, selection behavior, interaction patterns, or other externally obtained evaluation information.

A “feedback-limited condition” refers to a condition in which user intervention or external user feedback is unavailable, delayed, sparse, unreliable, or otherwise insufficient for continuous response-quality improvement.

“Combined feedback” refers to feedback generated by combining internal feedback and external feedback. In some embodiments, when external feedback is unavailable, the system may use internal feedback without external feedback. When external feedback is available, combined feedback may be generated by weighting internal feedback and external feedback. In some embodiments, the system may generate internal feedback based on verified static content and may use the internal feedback to adjust one or more response control parameters under a feedback-limited condition.

In some embodiments, when external feedback is available, the system may combine the external feedback with the internal feedback to generate combined feedback for adjusting a content-expression balance control value, a weighting factor, a response quality evaluation parameter, or another response control parameter.

“Governance reference information” refers to information used by the system as a reference basis for generating internal governance feedback or adjusting one or more response-governance control parameters.

In some embodiments, the governance reference information may include verified static content, response evaluation information, internal feedback information, information generated during response quality verification, information generated during alternative processing, information generated during output structuring, information indicating a response control condition, information indicating an alternative processing operation, information associated with a previously generated response output, information associated with a previously formed final user-facing output, or any combination thereof.

“Internal governance feedback” refers to feedback generated by the system based on governance reference information for adjusting, determining, or influencing one or more response-governance control parameters. In some embodiments, the internal governance feedback may include an information-related feedback value, an expression-related feedback value, a reliability-related feedback value, a safety-related feedback value, an output-control feedback value, a fallback-related feedback value, or a combination thereof.

In some embodiments, internal feedback generated based on verified static content may be used as one source of internal governance feedback, without limiting the internal governance feedback to such internal feedback.

A “response-governance control parameter” refers to a control parameter used to adjust, determine, or influence one or more operations in a generative AI response governance process. In some embodiments, the response-governance control parameter may control a degree of reliance on verified static content, fallback activation sensitivity, alternative-processing intensity, response reconstruction intensity, final-output use control intensity, response-control state determination sensitivity, content-expression balance, a threshold condition for activating alternative processing, or another response processing condition.

A “self-regulation mechanism” refers to a mechanism for adjusting a response control parameter based on feedback while limiting excessive variation. In some embodiments, the self-regulation mechanism may adjust the content-expression balance control value using a nonlinear adjustment term, boundary condition, allowable range, learning rate, or a combination thereof. In some embodiments, the content-expression balance control value may be adjusted using a nonlinear self-regulation mechanism.

The nonlinear self-regulation mechanism may provide a larger adjustment magnitude when the content-expression balance control value is within an intermediate range and may reduce the adjustment magnitude as the content-expression balance control value approaches opposite boundary values. The adjusted content-expression balance control value may be used in calculating a block-level evaluation value, determining a verified static content connection or integration operation, structuring a final user-facing output, or adjusting a response control parameter for a subsequent query.

In some embodiments, the self-regulation mechanism may dynamically adjust a response-governance control parameter based on internal governance feedback generated from governance reference information. The response-governance control parameter may be constrained within an allowable control range. The allowable control range may include one or more boundary values, and a target operating range may be defined within the allowable control range.

The self-regulation mechanism may exhibit nonlinear adjustment behavior in which an adjustment magnitude of the response-governance control parameter is greater within the target operating range than near one or more boundary values of the allowable control range. In some embodiments, the nonlinear adjustment behavior may reduce over-correction or oscillation of the response-governance control parameter across successive response processing cycles. For example, when the response-governance control parameter is within the target operating range, the system may respond more sensitively to internal governance feedback.

When the response-governance control parameter approaches a boundary value of the allowable control range, the system may reduce the adjustment magnitude to stabilize subsequent response processing.

A “response quality condition” refers to a condition that a response output is required to satisfy in order to be used, without substitution or alternative processing, in forming a final user-facing output. In some embodiments, whether the response quality condition is satisfied may be determined based on one or more predefined threshold values, rules, ranges, criteria, or combinations thereof.

A “response quality indicator” or “R” refers to a response-level evaluation value representing overall quality of a response output. In some embodiments, the response quality indicator (R) may be used as a response-level criterion for determining whether a response output satisfies a response quality condition. When the response quality condition is not satisfied, the response quality indicator (R) may be compared with one or more predefined threshold values to determine whether to activate alternative processing for the response output.

A “response quality threshold value” or “T” refers to a reference threshold value used for comparing a response quality indicator (R) and determining whether a response quality condition is satisfied. In some embodiments, T may represent a base threshold value from which one or more derived threshold values, such as 0.7·T and 0.4·T, may be calculated for determining different degrees of deficiency or corresponding alternative processing operations.

In contrast, information accuracy, a comprehensive evaluation index, content relevance, or another block-level evaluation value may be used to identify, select, preserve, replace, or reconstruct one or more semantic blocks after the response-level determination has been made. In some embodiments, the response quality indicator may be determined based on one or more response-level components, including style consistency, purpose compatibility, format coherence, domain compatibility, or a combination thereof. The response quality indicator may be used to determine whether substitution, alternative processing, or another response-control operation is required.

“Alternative processing” refers to processing performed when a response quality condition is not satisfied. In some embodiments, alternative processing may include replacing one or more deficient semantic blocks, preserving one or more non-deficient semantic blocks, reconstructing a response output around one or more selected semantic blocks, preventing at least a portion of a generated response output from contributing to a final user-facing output, or forming a final user-facing output using verified static content.

In certain embodiments, alternative processing may be activated based on a response quality condition determined using the response quality indicator (R). After activation, the system may use information accuracy, a comprehensive evaluation index, content relevance, or another block-level evaluation value to determine which semantic block is to be replaced, preserved, rearranged, reconstructed, omitted, excluded, or not used.

In some embodiments, omitting, excluding, or not using a selected semantic block, or a portion thereof, may each refer to preventing the selected semantic block or portion from contributing to formation of the final user-facing output. A corresponding portion of the final user-facing output may instead be formed using pre-validated verified static content, including as part of semantic-block-level replacement, core-block-based reconstruction, or formation of the final user-facing output using verified static content.

In some embodiments, a “deficiency condition” refers to a condition in which a response quality indicator (R), or another response quality condition, does not satisfy one or more predefined threshold values.

A “degree of deficiency” refers to a level, range, or category of deficiency determined according to a relationship between the response quality indicator (R) and one or more predefined threshold values.

In some embodiments, the response quality verification unit or the alternative processor may manage one or more response-control states associated with the response quality condition, the deficiency condition, or the degree of deficiency. The response-control states may include, for example, a state in which the generated response output is permitted to be used without substitution, a state in which one or more semantic blocks are selected for substitution, preservation, rearrangement, or reconstruction, or a state in which at least a portion of the generated response output is not used in forming the final user-facing output.

In some embodiments, the response-control states may be discrete states associated with a reliability condition of the response output, and the response quality verification unit or the alternative processor may determine an applicable response-control state and perform a corresponding predetermined response-control operation.

In some embodiments, when a response quality condition is not satisfied or when a deficiency condition is satisfied, the system may perform a predetermined response-control operation corresponding to the response-control state.

In some embodiments, after the response output has been generated, the system may determine an applicable response-control state based on a response quality condition associated with the response output, and may perform a predetermined response-control operation corresponding to the applicable response-control state to control whether at least a portion of the response output is used in forming the final user-facing output.

The predetermined response-control operation may include omitting, excluding, or not using a selected semantic block in forming the final user-facing output, reconstructing a response output around one or more selected semantic blocks, forming at least a portion of the final user-facing output using pre-validated verified static content, or controlling whether generated response content is used in forming the final user-facing output.

In some embodiments, the plurality of response-control states described herein may correspond to alternative processing stages that are applied differentially according to a degree of deficiency of a response output. The alternative processing stages may include individual block replacement, in which one or more semantic blocks having low evaluation values are selectively replaced while semantic blocks having high evaluation values are preserved; core block-centered reconstruction, in which one or more core semantic blocks are preserved or used as a basis for reconstruction; and formation of at least a portion of a final user-facing output using pre-validated verified static content. In some embodiments, an alternative processing operation corresponding to a more severe degree of deficiency modifies a greater portion of the response output than an alternative processing operation corresponding to a less severe degree of deficiency.

In some embodiments, an operation corresponding to an applicable response-control state may include one or more of the alternative processing stages described above. The applicable response-control state or alternative processing stage may be determined based on a relationship between a response quality indicator and one or more threshold values, and one or more block-level evaluation values may be used to determine which semantic blocks are preserved, replaced, rearranged, or reconstructed.

### System Components and Their Functions

Based on the concepts described above, the system may include a plurality of functionally connected modules. Each module may perform a corresponding function while operating within the overall system. In some embodiments, the modules may cooperate to improve reliability, structuring, and quality control of artificial intelligence response outputs.

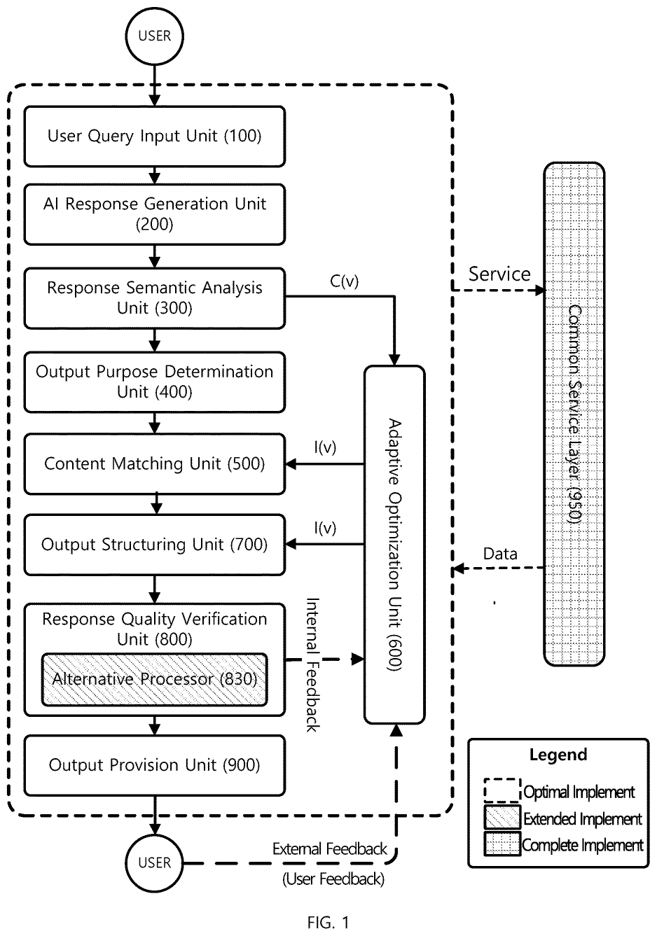

As illustrated in FIG. 1, the system may include a User Query Input Unit (100), an AI Response Generation Unit (200), a Response Semantic Analysis Unit (300), an Output Purpose Determination Unit (400), a Content Matching Unit (500), an Adaptive Optimization Unit (600), an Output Structuring Unit (700), a Response Quality Verification Unit (800), an Output Provision Unit (900), and, in certain implementations, a Common Service Layer (950).

In some embodiments, the Output Structuring Unit (700) and the Adaptive Optimization Unit (600) may provide core technical functions of the system. The Output Structuring Unit (700) may structure dynamically generated response content and verified static content according to a user query, an output purpose, or a domain characteristic. The Adaptive Optimization Unit (600) may support autonomous optimization by adjusting one or more response control parameters based on internal feedback, external feedback, or a combination thereof.

In some embodiments, the system may use a comprehensive evaluation index (I(v)) as a common block-level decision criterion. The comprehensive evaluation index (I(v)) may be used for determining a verified static content connection method, determining block placement order, selecting a block for substitution, or performing alternative processing. By using the comprehensive evaluation index (I(v)) across multiple processing stages, the system may provide consistent decision-making while reducing implementation complexity.

For example, the Content Matching Unit (500) may use the comprehensive evaluation index (I(v)) to determine a method for connecting verified static content to a semantic block. The Output Structuring Unit (700) may use the comprehensive evaluation index (I(v)) to determine placement priority or ordering of semantic blocks within an output template. The Alternative Processor (830) may use the comprehensive evaluation index (I(v)) to determine whether a semantic block is preserved, replaced, or used as a basis for reconstruction when a response quality condition is not satisfied.

The following describes individual components of the system in greater detail.

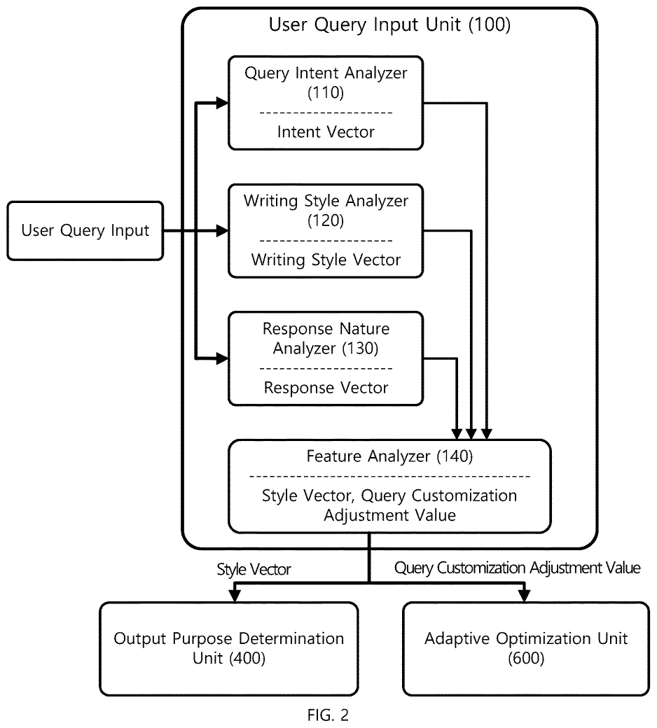

The User Query Input Unit (100) may receive a natural language query from a user and analyze the query to determine query intent, stylistic characteristics, response requirements, or other query-related features. In some embodiments, the User Query Input Unit (100) may generate a style vector and a query customization adjustment value based on the analysis of the user query. This process may be performed as illustrated in FIG. 2.

In some embodiments, the User Query Input Unit (100) may include a Query Intent Analyzer (110), a Writing Style Analyzer (120), a Response Nature Analyzer (130), and a Feature Analyzer (140). The Feature Analyzer (140) may integrate analysis results from one or more of the Query Intent Analyzer (110), the Writing Style Analyzer (120), and the Response Nature Analyzer (130). The integrated analysis result may be used to generate the style vector and the query customization adjustment value.

In some embodiments, the style vector may be generated by extracting one or more query-level features from the user query. The query-level features may include query intent, requested output purpose, requested level of detail, expertise level, tone requirement, response complexity requirement, readability requirement, response length requirement, domain characteristic, explanation depth, comparison requirement, guidance requirement, or another response-structuring characteristic. The User Query Input Unit (100) may convert the extracted query-level features into numerical, categorical, or vectorized values to form the style vector.

In some embodiments, the Query Intent Analyzer (110) may identify an intent of the user query, such as explanation, summary, comparison, guidance, diagnosis support, review, recommendation, or another query intent. The Writing Style Analyzer (120) may identify an expression requirement, such as easy explanation, professional explanation, concise answer, detailed answer, formal style, informal style, step-by-step explanation, or another writing style requirement. The Response Nature Analyzer (130) may identify a response nature, such as factual explanation, procedural guidance, comparative analysis, risk analysis, or educational explanation.

The Feature Analyzer (140) may combine outputs of the Query Intent Analyzer (110), the Writing Style Analyzer (120), and the Response Nature Analyzer (130) to generate the style vector.

In some embodiments, the User Query Input Unit (100) may extract the style vector and the query customization adjustment value from a current user query based on query-level characteristics included in the current user query, without requiring stored user profile data or long-term behavioral tracking to determine the response structure, expression style, or output purpose for the current response cycle. Accordingly, the system may adapt the response structure, expression style, or output purpose based on query-local characteristics of the current user query. Such query-local extraction may support response structuring in which response characteristics are determined based on immediate requirements included in the current user query.

In some embodiments, the style vector may include values representing one or more of an intent component, a style component, a response-depth component, a domain component, an output-purpose component, and a tone component. The values may be determined using keyword matching, rule-based classification, machine-learning classification, embedding similarity, prompt pattern analysis, domain-specific dictionaries, or a combination thereof.

The Feature Analyzer (140) may transmit the style vector to the Output Purpose Determination Unit (400) for output purpose classification or template selection. The Feature Analyzer (140) may also transmit the query customization adjustment value to the Adaptive Optimization Unit (600) for adjustment of a content-expression balance control value (λ). For example, the Feature Analyzer (140) may detect a simplicity requirement, an expertise requirement, an information-depth requirement, or another query-specific requirement from the user query. The original user query may be transmitted to the AI Response Generation Unit (200).

The AI Response Generation Unit (200) may generate a natural language response output based on the user query. In some embodiments, the AI Response Generation Unit (200) may use a generative AI model to generate the response output. In some embodiments, the AI Response Generation Unit (200) may be implemented using an external generative artificial intelligence service, an embedded generative model, a local inference model, or another response generation module. The generated response output may be transmitted to the Response Semantic Analysis Unit (300).

In some embodiments, the AI Response Generation Unit (200) may operate as a generative inference module, and one or more response-control modules, including the Response Quality Verification Unit (800), the Alternative Processor (830), or the Output Structuring Unit (700), may determine whether generated response content is used, replaced, supplemented, or excluded in forming a final user-facing output.

In some embodiments, one or more response-control modules may perform response-control operations separately from the response generation operation. The response-control operations may include determining whether generated response content is used, replaced, supplemented, omitted, excluded, or otherwise not used in forming a final user-facing output, based on a response quality condition, block-level information accuracy, a predefined threshold condition, or a combination thereof.

In some embodiments, the system may distinguish between a response generation operation and a final-output formation operation. The response generation operation may generate a response output, and the final-output formation operation may determine whether generated response content is used, replaced, supplemented, omitted, excluded, or otherwise not used in forming the final user-facing output. In this manner, the system may control whether generated response content is used in forming the final user-facing output without requiring termination of the generative artificial intelligence model.

In some embodiments, the response generation operation and the response-control operation may be implemented as separate functional stages, separate software modules, separate service components, separate processing routines, or a combination thereof. The response-control operation may determine whether generated response content is used, replaced, supplemented, omitted, excluded, or otherwise not used in forming the final user-facing output based on a response quality condition, a block-level evaluation value, a deficiency condition, or a response-control state.

In some embodiments, one or more response-control modules may determine whether generated response content is permitted to be used in forming the final user-facing output separately from the response generation operation.

In some embodiments, when a response-control state indicates that generated response content is not to be used in forming the final user-facing output, the system may form at least a portion of the final user-facing output using pre-validated verified static content.

The Response Semantic Analysis Unit (300) may divide the generated response output into semantic blocks and evaluate information accuracy for one or more of the semantic blocks. In some embodiments, the Response Semantic Analysis Unit (300) may include a Segmenter (310), an Element Evaluator (320), and an Accuracy Calculator (330). The Segmenter (310) may divide the generated response output into semantic blocks. In some embodiments, the Segmenter (310) may divide the generated response output into semantic blocks using one or more segmentation criteria.

The segmentation criteria may include sentence boundaries, paragraph boundaries, clause boundaries, discourse markers, topic changes, semantic similarity between adjacent text units, output-template slots, or a combination thereof. For example, the Segmenter (310) may first divide the response output into sentence-level units and may then group adjacent sentence-level units into a semantic block when the adjacent units have semantic similarity above a predefined threshold or share a common topic, entity, output purpose, or logical function.

In some embodiments, the Segmenter (310) may use a rule-based segmentation method, a machine-learning-based segmentation method, an embedding-based similarity method, a natural language processing parser, or a combination thereof. For example, the Segmenter (310) may identify sentence boundaries using punctuation and syntactic structure, calculate semantic similarity between adjacent units using vector representations, and merge adjacent units when the semantic similarity satisfies a grouping condition.

In another example, the Segmenter (310) may separate a response output into different semantic blocks according to template slots, such as a definition block, explanation block, comparison block, guidance block, caution block, or reference block.

In some embodiments, each semantic block may be assigned metadata indicating at least one of a block identifier, position information, topic information, semantic role, output-template slot, domain label, or relationship to one or more adjacent semantic blocks. The metadata may be used by the Response Semantic Analysis Unit (300), the Content Matching Unit (500), the Output Structuring Unit (700), or the Alternative Processor (830) for information accuracy evaluation, content matching, block placement, substitution, preservation, rearrangement, or reconstruction.

The Element Evaluator (320) may analyze information components of the semantic blocks and may calculate intrinsic significance (CS), contextual connectivity (CC), and output purpose fitness (CO) for one or more semantic blocks. The Element Evaluator (320) may provide the calculated CS, CC, and CO values to the Accuracy Calculator (330).

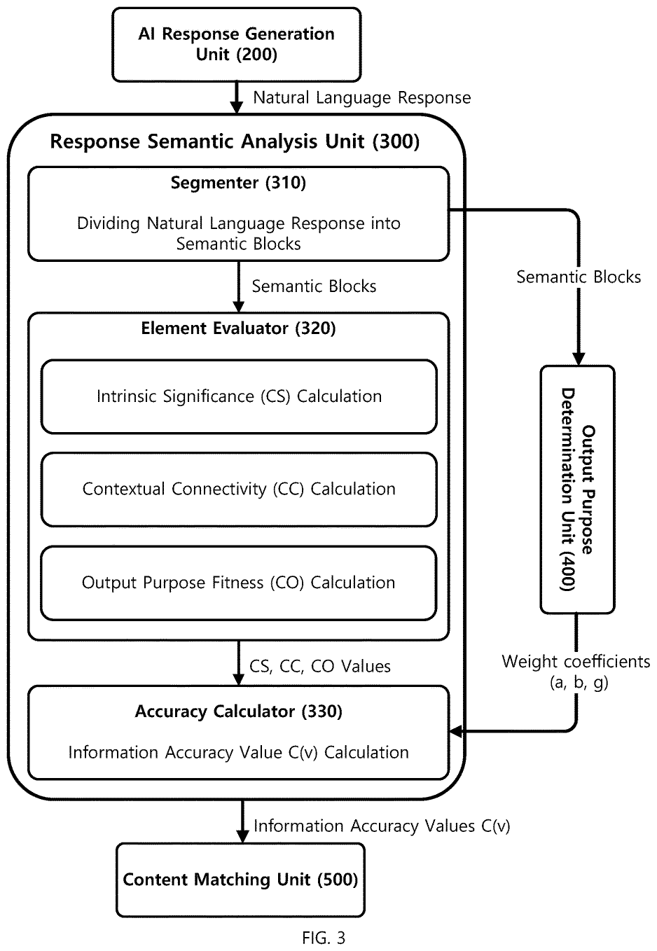

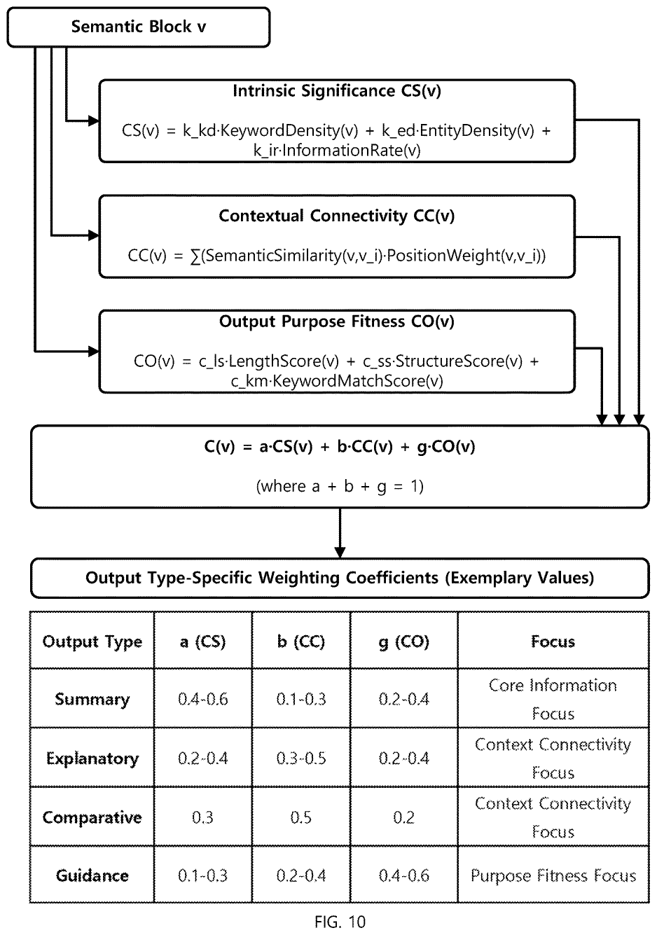

The Accuracy Calculator (330) may determine information accuracy (C(v)) for a semantic block v by combining the intrinsic significance (CS), contextual connectivity (CC), and output purpose fitness (CO) values received from the Element Evaluator (320), using weighting factors provided according to the classified output purpose. In some embodiments, weighting factors used for calculating information accuracy may be determined or provided according to a classified output purpose, a domain characteristic, a response type, or an implementation requirement. This process may be performed as illustrated in FIGS. 3 and 10.

The Output Purpose Determination Unit (400) may classify an output purpose of the response and determine an output template corresponding to the classified output purpose. In some embodiments, the output purpose may include an explanatory purpose, a summary purpose, a comparative purpose, a guidance purpose, or another output purpose.

In some embodiments, the Output Purpose Determination Unit (400) may perform an initial output-purpose classification based on the style vector received from the User Query Input Unit (100), one or more semantic blocks received from or derived by the Response Semantic Analysis Unit (300), or a combination thereof. The Output Purpose Determination Unit (400) may determine or provide weighting factors for information accuracy calculation according to the initially classified output purpose, a domain characteristic, a response type, or an implementation requirement.

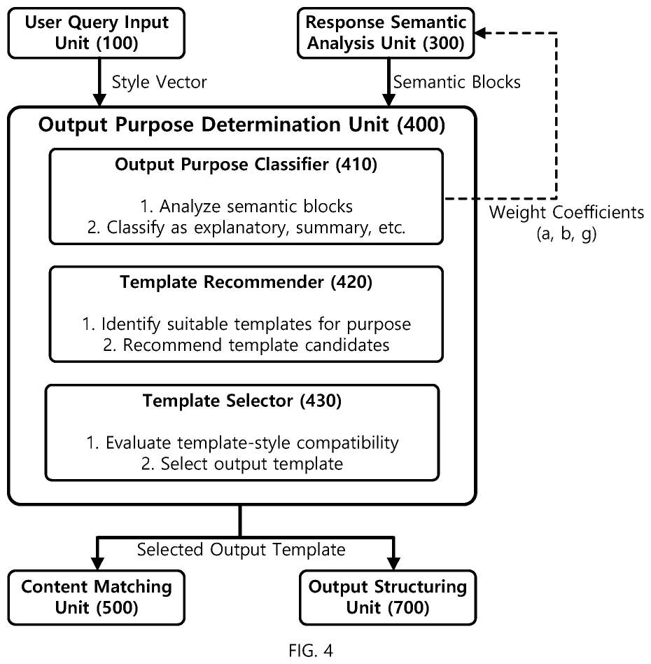

In some embodiments, after information accuracy values have been calculated by the Response Semantic Analysis Unit (300), the Output Purpose Determination Unit (400) may refine, confirm, or update the output-purpose classification or the corresponding output template based on the calculated information accuracy values. This process may be performed as illustrated in FIG. 4.

In some embodiments, the Output Purpose Determination Unit (400) may include an Output Purpose Classifier (410), a Template Recommender (420), and a Template Selector (430). The Template Selector (430) may select an output template based on compatibility between the style vector and characteristics of available templates.

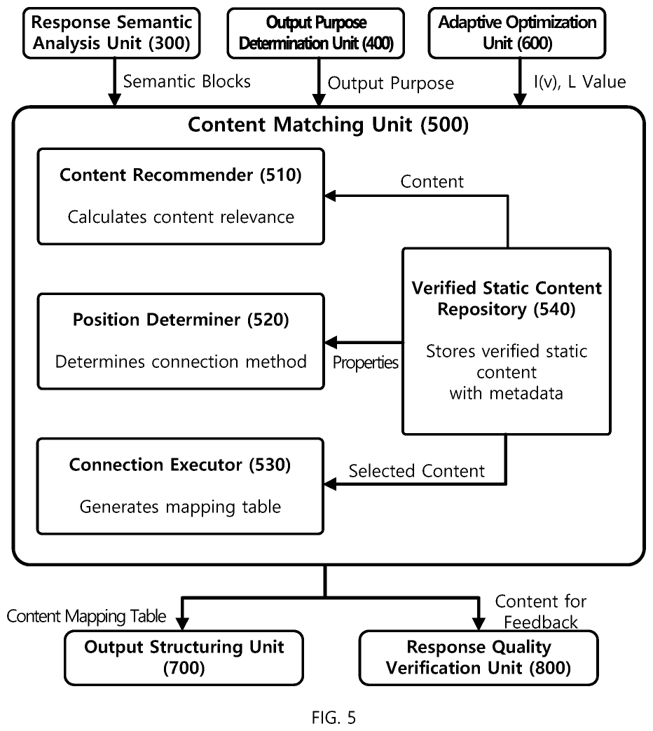

The Content Matching Unit (500) may determine a relationship between one or more semantic blocks and one or more pieces of verified static content. In some embodiments, the Content Matching Unit (500) may determine a verified static content connection method based on content relevance, a block-level evaluation value, content size, content type, the content-expression balance control value (λ), or a combination thereof. This process may be performed as illustrated in FIG. 5.

In some embodiments, verified static content may be selected or connected based on characteristics of a semantic block, including a semantic role, an output purpose, a domain, content relevance, or an information-accuracy requirement, so as to maintain semantic continuity or contextual consistency within the final user-facing output.

In some embodiments, the Content Matching Unit (500) may include a Content Recommender (510), a Position Determiner (520), a Connection Executor (530), and a Verified Static Content Repository (540). The Content Recommender (510) may calculate content relevance (CR) between a semantic block and verified static content. The Position Determiner (520) may determine a connection method, such as inline insertion, reference-based connection, or separate-section presentation. The Connection Executor (530) may generate a content mapping table representing connection information between semantic blocks and verified static content.

The Verified Static Content Repository (540) may store verified static content by domain, type, topic, or another classification criterion.

In some embodiments, verified static content stored in the Verified Static Content Repository (540) may be obtained from one or more authoritative sources, including institutional publications, academic papers, technical standards, official statistics, government or regulatory materials, domain-specific guidelines, expert-reviewed materials, or other reliable reference sources. Each item of verified static content may be stored together with metadata indicating a source identifier, domain, topic, content type, verification authority, verification date, version information, reliability level, applicable jurisdiction or domain, expiration information, revalidation schedule, or a combination thereof.

In some embodiments, the Verified Static Content Repository (540) may update, replace, deactivate, or mark as requiring revalidation a stored item when the item is outdated, superseded, inconsistent with an updated policy or domain rule, or otherwise fails to satisfy a verification condition. Such metadata may be used by the Content Matching Unit (500), the Response Quality Verification Unit (800), or the Internal Feedback Generator (820) when selecting verified static content, calculating content relevance, generating internal feedback, or forming a final user-facing output.

The Adaptive Optimization Unit (600) may calculate the comprehensive evaluation index (I(v)) and adjust the content-expression balance control value (λ). In some embodiments, the Adaptive Optimization Unit (600) may determine the comprehensive evaluation index (I(v)) based on information accuracy (C(v)), expression style (S(v)), and the content-expression balance control value (λ). The Adaptive Optimization Unit (600) may also adjust the content-expression balance control value (λ) based on a query customization adjustment value, internal feedback, external feedback, or a combination thereof.

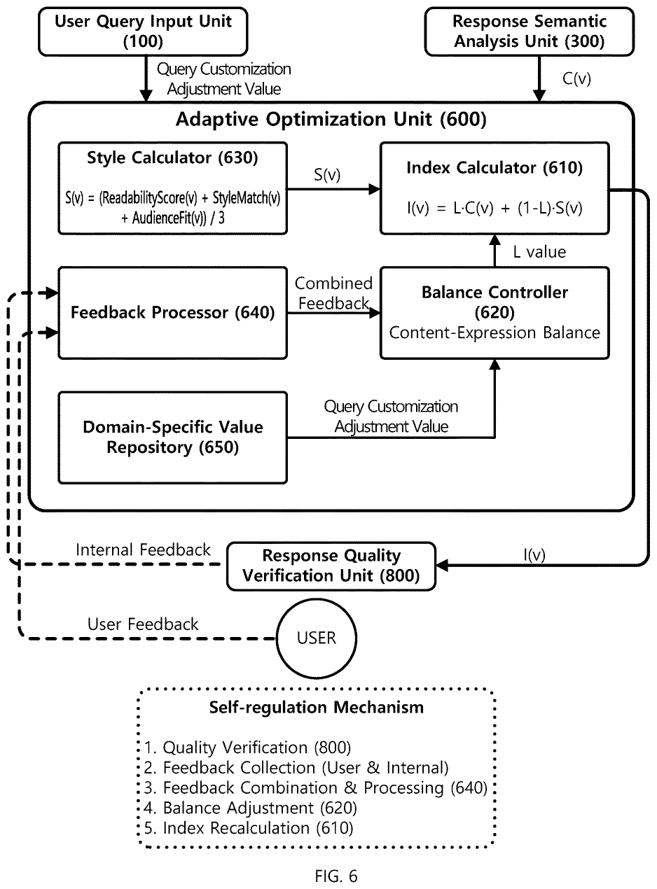

This process may be performed as illustrated in FIG. 6.

In some embodiments, the Adaptive Optimization Unit (600) may include an Index Calculator (610), a Balance Controller (620), a Style Calculator (630), a Feedback Processor (640), and a Domain-Specific Value Repository (650). In some embodiments, the Adaptive Optimization Unit (600) may also adjust one or more response-governance control parameters.

A response-governance control parameter may include a content-expression balance control value, a verified-content reliance level, an alternative-processing sensitivity, a response-control state determination sensitivity, a final-output use control intensity, or another parameter used to control subsequent response processing.

In some embodiments, the Adaptive Optimization Unit (600) may obtain governance reference information associated with a response output, a final user-facing output, response evaluation information, internal feedback information, information indicating an alternative processing operation, or information indicating a response control condition. The Adaptive Optimization Unit (600) may generate or receive internal governance feedback based on the governance reference information and may dynamically adjust a response-governance control parameter using a nonlinear self-regulation mechanism.

The adjusted response-governance control parameter may be applied to a subsequent response processing operation. In some embodiments, the response-governance control parameter may include the content-expression balance control value (λ), a verified-content reliance level, an alternative-processing sensitivity, a response-control state determination sensitivity, a final-output use control intensity, or another parameter used to control subsequent response processing.

For example, the adjusted response-governance control parameter may be used in calculating a block-level evaluation value, selecting verified static content, determining a verified static content connection method, determining whether to activate alternative processing, determining a response-control state, determining whether generated response content is used in forming a final user-facing output, reconstructing a response output, or forming a final user-facing output.

The Index Calculator (610) may calculate the comprehensive evaluation index (I(v)). The Balance Controller (620) may adjust the content-expression balance control value (λ). The Style Calculator (630) may calculate an expression style value (S(v)) for one or more semantic blocks. The Feedback Processor (640) may process internal feedback, external feedback, or combined feedback. The Domain-Specific Value Repository (650) may store initial values, allowable ranges, or domain-specific settings for the content-expression balance control value (λ).

The Output Structuring Unit (700) may generate a structured response output by arranging semantic blocks and integrating verified static content according to an output template. In some embodiments, the Output Structuring Unit (700) may include a Block Placement Optimizer (710), a Verified Static Content Integrator (720), and an Output Preparer (730). The Block Placement Optimizer (710) may determine placement of semantic blocks based on semantic similarity, output template slots, and the comprehensive evaluation index (I(v)).

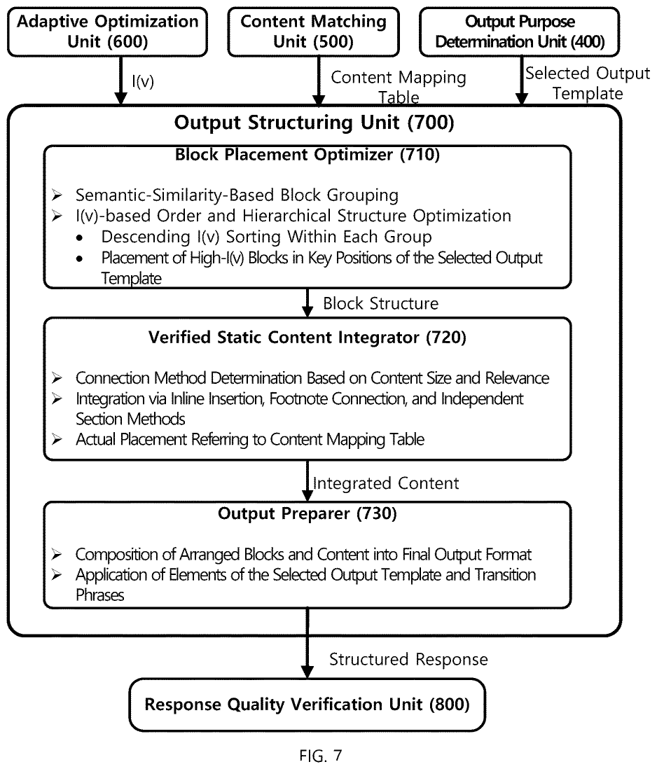

The Verified Static Content Integrator (720) may integrate verified static content according to the content mapping table. The Output Preparer (730) may prepare the structured response output by applying template structures, transition phrases, or formatting rules. This process may be performed as illustrated in FIG. 7.

The Response Quality Verification Unit (800) may evaluate overall quality of a structured response output. In some embodiments, the Response Quality Verification Unit (800) may include a Response Quality Calculator (810), an Internal Feedback Generator (820), and, in certain implementations, an Alternative Processor (830). The Response Quality Calculator (810) may calculate a response quality indicator (R) based on one or more factors including style consistency, purpose compatibility, format coherence, and domain compatibility.

The Internal Feedback Generator (820) may generate internal feedback based on verified static content or a response output including verified static content. In some embodiments, the internal feedback may include an information-related feedback component, an expression-related feedback component, or both. The internal feedback may be transmitted to the Adaptive Optimization Unit (600) for adjustment of the content-expression balance control value (λ). In certain embodiments, an adjusted value may be applied to a later query processing cycle rather than modifying a current response output.

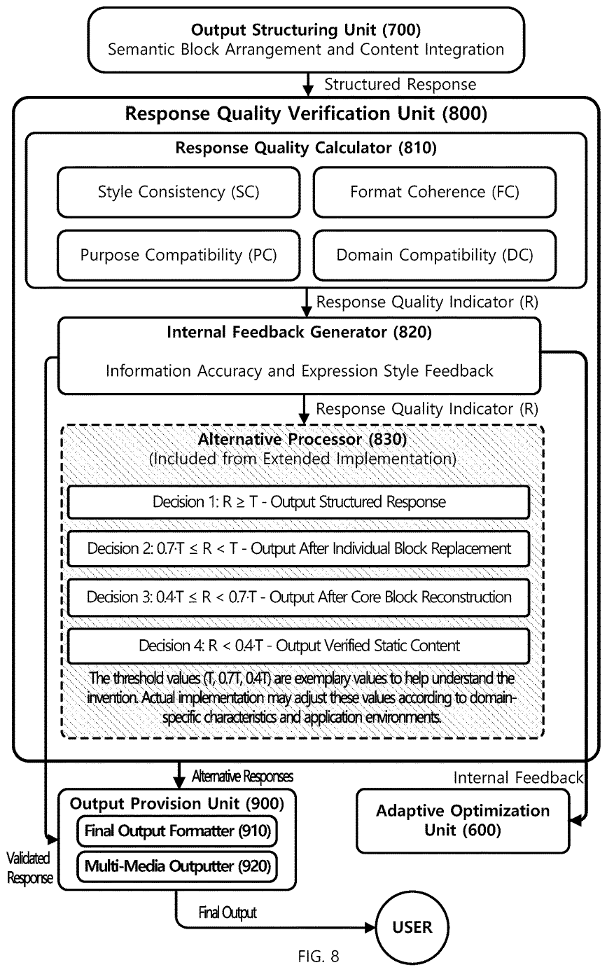

The Alternative Processor (830) may perform alternative processing when a response quality condition is not satisfied. In some embodiments, the Alternative Processor (830) may replace one or more deficient semantic blocks, preserve one or more non-deficient semantic blocks, reconstruct a response output around one or more selected semantic blocks, prevent at least a portion of a generated response output from contributing to a final user-facing output, or form a final user-facing output using verified static content. This process may be performed as illustrated in FIG. 8.

In some embodiments, the Response Quality Verification Unit (800), the Internal Feedback Generator (820), or the Alternative Processor (830) may generate information that is stored, maintained, or referenced for a subsequent response processing cycle. Such information may include response evaluation information, internal feedback information, information indicating whether a response quality condition was satisfied, information indicating a degree of deficiency, information indicating an alternative processing operation, or information indicating a response control condition.

In some embodiments, information indicating an alternative processing operation may indicate whether at least a portion of a previous response output was replaced, reconstructed, omitted, excluded, not used, or formed using verified static content. In some embodiments, information indicating a response control condition may indicate whether a previous response output was permitted to be used, partially not used, reconstructed, or replaced in forming a final user-facing output.

The stored, maintained, or referenced information may be used as governance reference information for generating internal governance feedback in a subsequent response processing cycle. The internal governance feedback may be used by the Adaptive Optimization Unit (600) to adjust a response-governance control parameter for subsequent response processing.

The Output Provision Unit (900) may provide the final user-facing output to a user or another system. In some embodiments, the Output Provision Unit (900) may include a Final Output Formatter (910) and a Multi-Media Outputter (920). The Final Output Formatter (910) may format the final user-facing output according to an output format. The Multi-Media Outputter (920) may provide the output through a screen display, document output, application programming interface response, or another output channel.

The Common Service Layer (950) may provide shared services used by one or more modules of the system. In some embodiments, the Common Service Layer (950) may include an Integrated Embedding Service (951), Common Calculation Utilities (952), an Integrated Classification Engine (953), and a Feedback Learning System (954). The Integrated Embedding Service (951) may provide vector conversion or embedding functions. The Common Calculation Utilities (952) may provide weighted summation, similarity calculation, normalization, or other calculation functions. The Integrated Classification Engine (953) may provide classification functions.

The Feedback Learning System (954) may aggregate feedback across sessions and support long-term optimization of domain-specific settings. For example, the Response Semantic Analysis Unit (300) may invoke the Integrated Embedding Service (951) to convert a generated response or a semantic block into a vector representation, and may invoke the Common Calculation Utilities (952) to calculate semantic similarity, contextual connectivity, normalization values, or weighted sums.

The Content Matching Unit (500) may use the Integrated Embedding Service (951) and the Common Calculation Utilities (952) to calculate content relevance between a semantic block and verified static content. The Output Purpose Determination Unit (400) may use the Integrated Classification Engine (953) to classify an output purpose or select a template candidate.

The Response Quality Verification Unit (800) may provide internal feedback or response evaluation information to the Feedback Learning System (954), and the Feedback Learning System (954) may use such information to support later adjustment of domain-specific settings, threshold conditions, or response-governance control parameters.

In some embodiments, the Integrated Embedding Service (951) may include a BERT-based encoder or another embedding encoder, model conversion matrix management, an embedding caching system, and context dynamic routing. The Common Calculation Utilities (952) may include a weighted-sum calculation engine, similarity calculation functions, a vector normalization module, and a matrix operation optimizer. The Integrated Classification Engine (953) may include a multi-purpose classification framework, a domain-specific classifier repository, a classification-result caching system, and classification ambiguity handling. The Feedback Learning System (954) may include a feedback collection interface, a normalization and conversion engine, module-specific feedback routing, and a feedback-based learning engine.

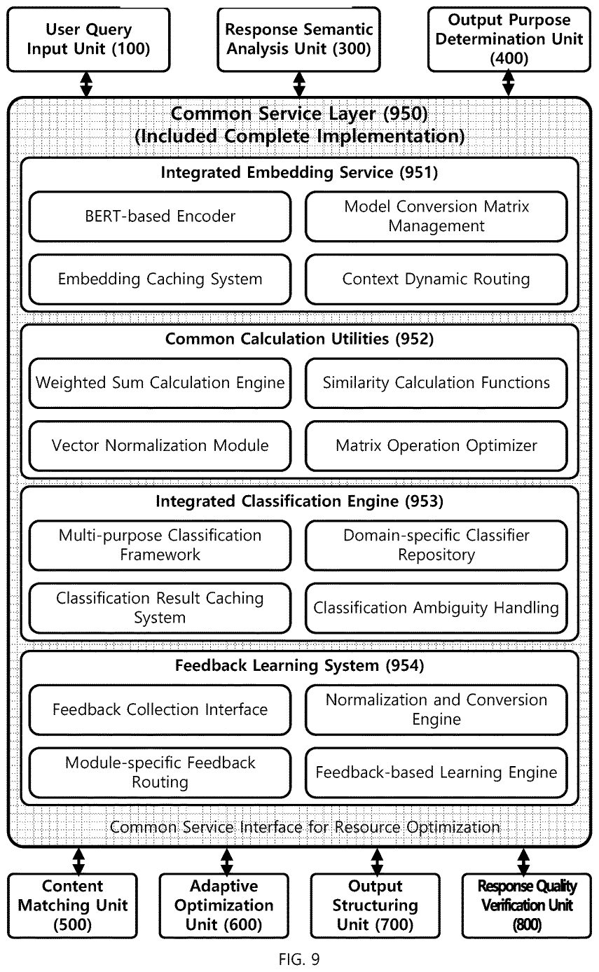

The configuration and functions of the Common Service Layer (950) may be as illustrated in FIG. 9.

### Three-Stage Implementation Configuration

In some embodiments, the system may be configured in a plurality of implementation stages according to an implementation environment, resource constraints, required reliability, or service requirements. The implementation stages may include an optimal implementation, an extended implementation, and a complete implementation. Each implementation stage may progressively expand functionality while maintaining autonomous optimization and output structuring capabilities.

In some embodiments, each implementation stage may use a comprehensive evaluation index (I(v)) as a common block-level decision criterion. The comprehensive evaluation index (I(v)) may be used by one or more modules to determine verified static content connection methods, semantic block placement, substitution decisions, or alternative processing. By using a common evaluation criterion across multiple processing stages, the system may maintain consistency in response structuring and quality control.

In an optimal implementation, the system may include a User Query Input Unit (100), an AI Response Generation Unit (200), a Response Semantic Analysis Unit (300), an Output Purpose Determination Unit (400), a Content Matching Unit (500), an Adaptive Optimization Unit (600), an Output Structuring Unit (700), a Response Quality Verification Unit (800), and an Output Provision Unit (900).

In the optimal implementation, the User Query Input Unit (100) may analyze a user query and generate a style vector and a query customization adjustment value. The AI Response Generation Unit (200) may generate a response output. The Response Semantic Analysis Unit (300) may divide the response output into semantic blocks and evaluate information accuracy. The Output Purpose Determination Unit (400) may classify an output purpose and select an output template. The Content Matching Unit (500) may identify or recommend verified static content.

The Adaptive Optimization Unit (600) may calculate a comprehensive evaluation index (I(v)) and adjust a content-expression balance control value (λ). The Output Structuring Unit (700) may generate a structured response output. The Response Quality Verification Unit (800) may evaluate the structured response output and generate internal feedback. The Output Provision Unit (900) may provide a final user-facing output.

In some embodiments, the optimal implementation may support autonomous response quality improvement by generating internal feedback based on verified static content. The internal feedback may be used to adjust the content-expression balance control value (λ) for a later query processing cycle. The optimal implementation may also support output structuring by arranging semantic blocks according to an output template and by connecting verified static content to one or more semantic blocks.

In an extended implementation, the system may further include an Alternative Processor (830). The Alternative Processor (830) may perform alternative processing when a response quality condition is not satisfied. In some embodiments, the response quality condition may be determined based on a response quality indicator (R), one or more threshold values, information accuracy associated with semantic blocks, the comprehensive evaluation index (I(v)), or a combination thereof.

In the extended implementation, the Alternative Processor (830) may replace one or more deficient semantic blocks with verified static content, preserve one or more non-deficient semantic blocks, reconstruct a response output around one or more selected semantic blocks, or form a final user-facing output using verified static content. The alternative processing may be applied in a current response cycle so that a final user-facing output can be provided even when an initially generated response output does not satisfy the response quality condition.

In some embodiments, the extended implementation may be used in domains or service environments requiring increased reliability of response outputs. For example, when a generated response output includes a portion having insufficient information accuracy, the Alternative Processor (830) may selectively replace that portion while preserving other portions. When the response output requires more substantial correction, the Alternative Processor (830) may reconstruct the response output using selected semantic blocks and verified static content.

When the response output does not satisfy a higher level of reliability requirement, the Alternative Processor (830) may form the final user-facing output using verified static content.

In a complete implementation, the system may further include a Common Service Layer (950). The Common Service Layer (950) may provide shared services used by multiple modules of the system. In some embodiments, the Common Service Layer (950) may include an Integrated Embedding Service (951), Common Calculation Utilities (952), an Integrated Classification Engine (953), and a Feedback Learning System (954).

In the complete implementation, the Integrated Embedding Service (951) may provide text-to-vector conversion or embedding functions. The Common Calculation Utilities (952) may provide weighted summation, similarity calculation, normalization, or other calculation functions. The Integrated Classification Engine (953) may provide classification functions used for style classification, output purpose classification, domain classification, or another classification operation. The Feedback Learning System (954) may aggregate feedback across multiple sessions and support long-term optimization of domain-specific settings.

Through these implementation stages, the system may provide a scalable configuration. The optimal implementation may provide core response structuring and autonomous optimization functions. The extended implementation may add alternative processing for response quality remediation. The complete implementation may add shared services and feedback learning functions for efficient operation and long-term optimization.

### Key Algorithms of the Invention

The following describes representative algorithms that may be used to implement the system described above. These algorithms may be used individually or in combination, depending on an implementation configuration, a target domain, a response quality requirement, or available computing resources.

In some embodiments, the algorithms may include a query customization adjustment value generation and application algorithm, a comprehensive evaluation index calculation algorithm, an information accuracy calculation algorithm, an expression style calculation algorithm, an internal feedback generation algorithm, an external feedback processing algorithm, a combined feedback algorithm, a self-regulation mechanism, a content connection method algorithm, an output structuring algorithm, a response quality indicator calculation algorithm, an alternative processing algorithm, and a feedback learning system algorithm.

In some embodiments, the algorithms may operate cooperatively. For example, a user query may be analyzed to determine a query customization adjustment value, a generated response output may be divided into semantic blocks, information accuracy and expression style may be evaluated for one or more semantic blocks, a comprehensive evaluation index may be calculated for each semantic block, verified static content may be selected or connected based on content relevance and the comprehensive evaluation index, and a final user-facing output may be structured according to an output purpose.

In some embodiments, a response quality indicator (R) may be calculated for a response output or a structured response output. When a response quality condition is not satisfied, alternative processing may be performed using verified static content. In addition, internal feedback generated based on verified static content may be used to adjust a content-expression balance control value (λ), thereby supporting autonomous response quality improvement under a feedback-limited condition.

The algorithms described below are exemplary implementations. The order, combination, and detailed parameters of the algorithms may be varied according to implementation requirements without departing from the scope of the present disclosure.

### Query Customization Adjustment Value Generation and Application Algorithm

In some embodiments, a query customization adjustment value generation and application algorithm may be used to determine a query customization adjustment value from a user query and apply the adjustment value to a content-expression balance control value (λ).

The Feature Analyzer (140) may integrate analysis results from one or more components, including the Query Intent Analyzer (110), the Writing Style Analyzer (120), and the Response Nature Analyzer (130). Based on the integrated analysis results, the Feature Analyzer (140) may generate one or more outputs associated with the user query.

In some embodiments, the Feature Analyzer (140) may generate a style vector and transmit the style vector to the Output Purpose Determination Unit (400). The style vector may be used for output purpose classification, template selection, or another response structuring operation.

In some embodiments, the Feature Analyzer (140) may also generate a query customization adjustment value. The query customization adjustment value may be determined based on query intent, writing style, response nature, expression requirements, information-depth requirements, expertise requirements, or other characteristics detected from the user query. The query customization adjustment value may be transmitted to the Adaptive Optimization Unit (600).

For example, when a user query includes an expression such as “explain it easily,” the expression may indicate a preference for understandability, friendliness, or reduced complexity. The Feature Analyzer (140) may interpret this expression together with query intent and response nature and may generate a query customization adjustment value corresponding to the detected preference.

In another example, when a user query includes an expression such as “explain professionally” or “explain in detail,” the Feature Analyzer (140) may generate a different query customization adjustment value corresponding to an increased information-depth or expertise requirement.

The Adaptive Optimization Unit (600) may apply the query customization adjustment value to a domain-specific base value of the content-expression balance control value (λ). In some embodiments, the resulting value may be used as a content-expression balance control value adjusted for the current query. The resulting value may be constrained within a predefined allowable range associated with a domain, an output purpose, a user query type, or another implementation condition.

In some embodiments, applying the query customization adjustment value to the content-expression balance control value (λ) may be performed in real time, including upon generation of the query customization adjustment value by the Feature Analyzer (140) and before one or more subsequent processing stages associated with the current user query. Accordingly, the Adaptive Optimization Unit (600) may immediately apply the query customization adjustment value to the content-expression balance control value (λ) for the current query.

Through this process, the system may provide query-specific response adaptation even when a persistent user profile is not used. The query customization adjustment value may allow different final user-facing outputs to be structured or provided for similar queries according to immediate requirements expressed in the user query.

### Comprehensive Evaluation Index Calculation Algorithm

In some embodiments, the Adaptive Optimization Unit (600) may calculate a comprehensive evaluation index (I(v)) for a semantic block v. The comprehensive evaluation index (I(v)) may be used to evaluate a block-level relationship between information accuracy and expression style.

In some embodiments, the comprehensive evaluation index (I(v)) may be calculated according to the following formula:

I(v)=λ·C(v)+(1−λ)·S(v)
where I(v) represents the comprehensive evaluation index of semantic block v, C(v) represents information accuracy of semantic block v, S(v) represents an expression style value of semantic block v, and λ represents a content-expression balance control value.

In some embodiments, when the value of λ increases, greater weight may be assigned to information accuracy. When the value of λ decreases, greater weight may be assigned to expression style. The value of λ may be set according to a domain, output purpose, query-specific characteristic, internal feedback, external feedback, or a combination thereof. A self-regulation mechanism for adjusting λ is described in further detail below.

The comprehensive evaluation index (I(v)) may serve as a block-level decision criterion used across a plurality of processing stages of the system. In some embodiments, the comprehensive evaluation index (I(v)) may be used for determining a verified static content connection method, determining block placement priority, selecting a semantic block for substitution, preserving a semantic block, reconstructing a response output, or performing alternative processing.

For example, the Content Matching Unit (500) may determine a connection method for verified static content based at least in part on the comprehensive evaluation index (I(v)). In some embodiments, a semantic block having a relatively high I(v) value may be directly integrated with verified static content, while another semantic block may be connected to verified static content through a reference-based connection or a separate-section presentation.

The Output Structuring Unit (700) may use the comprehensive evaluation index (I(v)) to determine placement priority or order of semantic blocks within an output template. For example, semantic blocks having relatively high I(v) values may be placed in more prominent positions of the output template or arranged earlier within a corresponding template slot.

The Alternative Processor (830) may use the comprehensive evaluation index (I(v)) to determine whether a semantic block is to be preserved, replaced, or used as a basis for reconstruction when a response quality condition is not satisfied. In some embodiments, a semantic block having a relatively high I(v) value may be preserved, while a semantic block having a relatively low I(v) value may be replaced with verified static content.

By using the comprehensive evaluation index (I(v)) across multiple processing stages, the system may provide consistent block-level decision-making for verified static content connection, output structuring, and alternative processing.

### Information Accuracy Calculation Algorithm

In some embodiments, the Response Semantic Analysis Unit (300) may calculate information accuracy (C(v)) for a semantic block v. The information accuracy (C(v)) may represent reliability, importance, or factual suitability of information included in the semantic block. This process may be performed as illustrated in FIG. 10.

In some embodiments, the information accuracy (C(v)) may be determined based on one or more component indicators, including intrinsic significance (CS), contextual connectivity (CC), and output purpose fitness (CO).

Intrinsic significance (CS) may represent an independent information value of a semantic block. In some embodiments, intrinsic significance (CS(v)) may be calculated according to the following formula:

CS(v)=k_kd·KeywordDensity(v)+k_ed·EntityDensity(v)+k_ir·InformationRate(v)
where k_kd, k_ed, and k_ir represent weighting coefficients corresponding to KeywordDensity, EntityDensity, and InformationRate, respectively. In some embodiments, the weighting coefficients may be normalized so that their sum is equal to 1.

KeywordDensity(v) may represent a frequency, importance, or density of core keywords included in semantic block v. EntityDensity(v) may represent a density of high-value information entities, such as technical terms, proper nouns, numerical data, domain-specific terms, or other significant entities. InformationRate(v) may represent a density of meaningful information in semantic block v.

In some embodiments, KeywordDensity(v) may be calculated based on a ratio between a number or weighted number of keywords identified in semantic block v and a length of semantic block v. For example, the keywords may be extracted using a domain-specific keyword dictionary, TF-IDF analysis, keyword matching, embedding-based keyword extraction, or another keyword extraction method. In some embodiments, keywords having higher domain relevance or higher output-purpose relevance may be assigned greater weights.

In some embodiments, EntityDensity(v) may be calculated based on a ratio between a number or weighted number of entities identified in semantic block v and a length of semantic block v. The entities may include technical terms, proper nouns, numerical values, standard names, legal provisions, medical terms, engineering terms, financial indicators, or other domain-specific information entities. The entities may be identified using named entity recognition, regular expression matching, domain dictionaries, terminology databases, ontology matching, or a combination thereof.

In some embodiments, InformationRate(v) may be calculated based on a ratio of meaningful information units to total linguistic units in semantic block v. The meaningful information units may include entities, numerical values, causal relations, procedural steps, definitions, constraints, comparison points, domain-specific facts, or other information-bearing units. In some embodiments, InformationRate(v) may be determined by identifying informative tokens, phrases, or propositions and normalizing the identified information units by sentence length, token count, or another length-related value.

In some embodiments, KeywordDensity(v), EntityDensity(v), and InformationRate(v) may each be normalized to a common range before being combined to calculate intrinsic significance (CS(v)). The normalization may be performed using min-max normalization, clipping, standard score normalization, rank-based normalization, or another normalization method.

These components may be calculated using keyword analysis, TF-IDF analysis, named entity recognition, domain-specific dictionaries, semantic analysis, or a combination thereof.

In some embodiments, weighting coefficients for intrinsic significance may vary according to domain characteristics. For example, in a medical domain, EntityDensity may be assigned a relatively high weight because drug names, disease names, numerical values, and specialized terms may be important. In an educational domain, KeywordDensity or conceptual keyword coverage may be assigned a relatively high weight. These values are exemplary, and other values may be used according to implementation requirements.

Contextual connectivity (CC) may represent a semantic relationship between semantic block v and one or more other semantic blocks included in the response output. In some embodiments, contextual connectivity (CC(v)) may be calculated according to the following formula:

CC(v)=Σ_i[SemanticSimilarity(v, v_i)·PositionWeight(v, v_i)]
where v represents a target semantic block and v_i represents another semantic block in the response output.

In some embodiments, SemanticSimilarity(v, v_i) may be calculated using vector representations of semantic blocks. For example, SemanticSimilarity(v, v_i) may be calculated according to the following formula:

SemanticSimilarity(v, v_i)=cos(Embedding(v), Embedding(v_i))
where Embedding(v) represents a vector representation of semantic block v and cos represents cosine similarity. Higher values may indicate stronger semantic similarity between semantic blocks.

PositionWeight(v, v_i) may represent a weight determined according to relative positions of semantic blocks. In some embodiments, PositionWeight(v, v_i) may be calculated according to the following formula:

PositionWeight(v, v_i)=1/(1+|position(v)−position(v_i)|)
where position(v) represents a position of semantic block v within the response output. Adjacent blocks may receive a relatively higher position weight, and blocks farther apart may receive a relatively lower position weight. This allows the system to reflect both semantic similarity and local contextual proximity.

Output purpose fitness (CO) may represent a degree to which semantic block v is suitable for an output purpose. In some embodiments, output purpose fitness (CO(v)) may be calculated according to the following formula:

CO(v)=c_ls·LengthScore(v)+c_ss·StructureScore(v)+c_km·KeywordMatchScore(v)
where c_ls, c_ss, and c_km represent weighting coefficients corresponding to LengthScore, StructureScore, and KeywordMatchScore, respectively. In some embodiments, these weighting coefficients may be normalized so that their sum is equal to 1.

LengthScore(v) may represent suitability of a length of semantic block v for a particular output purpose. StructureScore(v) may represent suitability of a syntactic or structural pattern of semantic block v for the output purpose. KeywordMatchScore(v) may represent a degree to which semantic block v includes vocabulary, terms, or expressions associated with the output purpose.

In some embodiments, information accuracy (C(v)) may be calculated by combining intrinsic significance (CS), contextual connectivity (CC), and output purpose fitness (CO). For example, information accuracy (C(v)) may be calculated according to the following formula:

C(v)=α·CS(v)+β·CC(v)+γ·CO(v)
where α, β, and γ represent weighting coefficients corresponding to intrinsic significance, contextual connectivity, and output purpose fitness, respectively. In some embodiments, α, β, and γ may be normalized so that their sum is equal to 1.

The weighting coefficients α, β, and γ may be determined according to an output purpose, a domain, a response type, a user query characteristic, or another implementation condition. For example, a summary output may assign a relatively higher weight to intrinsic significance, an explanatory output may assign a relatively higher weight to contextual connectivity, a comparative output may assign a relatively higher weight to contextual relationship between semantic blocks, and a guidance output may assign a relatively higher weight to output purpose fitness.

In some embodiments, exemplary output-purpose-specific weighting ranges may be used. For example, for a summary output, α may be set to 0.4-0.6, β may be set to 0.1-0.3, and γ may be set to 0.2-0.4. For an explanatory output, α may be set to 0.2-0.4, β may be set to 0.3-0.5, and γ may be set to 0.2-0.4. For a comparative output, α may be set to 0.3, β may be set to 0.5, and γ may be set to 0.2. For a guidance output, α may be set to 0.1-0.3, β may be set to 0.2-0.4, and γ may be set to 0.4-0.6. These values are exemplary and may be adjusted according to domain characteristics, output requirements, or implementation conditions.

These weighting relationships are exemplary and may be changed according to system requirements.

In some embodiments, the Output Purpose Determination Unit (400) may determine one or more weighting coefficients used by the Response Semantic Analysis Unit (300). For example, the Output Purpose Classifier (410) may classify an output purpose as an explanatory purpose, a summary purpose, a comparative purpose, a guidance purpose, or another output purpose. Based on the classified output purpose, the Output Purpose Classifier (410) may provide weighting coefficients α, β, and γ to the Accuracy Calculator (330).

In some embodiments, each component score used to calculate information accuracy may be normalized to a common range. For example, intrinsic significance, contextual connectivity, and output purpose fitness may be normalized to a range between 0 and 1. Normalization may reduce imbalance between component scores having different scales or units. A min-max normalization method, standard score normalization method, clipping method, or another normalization method may be used.

In some embodiments, domain characteristics may affect evaluation criteria. A medical domain may emphasize technical terminology accuracy, specialized entities, numerical values, or verified guideline consistency. An educational domain may emphasize concept clarity, learning sequence, or understandability. A legal domain may emphasize terminology precision, statutory structure, or contextual relationship between provisions. These examples are illustrative and are not intended to limit the scope of the present disclosure.

### Expression Style Calculation Algorithm

In some embodiments, the Adaptive Optimization Unit (600) or the Style Calculator (630) may calculate an expression style value (S(v)) for a semantic block v. The expression style value (S(v)) may represent suitability of expression, readability, or audience appropriateness of the semantic block.

In some embodiments, the expression style value (S(v)) may be determined based on one or more component values, including ReadabilityScore(v), StyleMatch(v), and AudienceFit(v). In one example, when three component values are used, the expression style value (S(v)) may be calculated according to the following formula:

S(v)=(ReadabilityScore(v)+StyleMatch(v)+AudienceFit(v))/3

ReadabilityScore(v) may represent readability or clarity of semantic block v. In some embodiments, ReadabilityScore(v) may be determined based on sentence structure complexity, vocabulary difficulty, sentence length, terminology difficulty, or another readability-related factor.

StyleMatch(v) may represent a degree to which semantic block v matches an expression style associated with an output purpose. For example, an explanatory output, a summary output, a comparative output, or a guidance output may have different expression patterns, and StyleMatch(v) may be calculated based on similarity between semantic block v and an expression pattern associated with the corresponding output purpose.

In some embodiments, AudienceFit(v) may represent how well the expression level of a semantic block v matches the intended audience or the expertise level inferred from the user query. For example, AudienceFit(v) may be estimated based on vocabulary level, technical terminology density, sentence complexity, explanation depth, explicit expertise indicators, or readability characteristics of the user query and the semantic block v.

In some embodiments, AudienceFit(v) may be calculated as a similarity score or compatibility score between the vocabulary level, technical density, expertise indicators, or readability characteristics of the user query and corresponding characteristics of the semantic block v. Accordingly, a semantic block may receive a higher AudienceFit(v) value when its expression level, terminology density, and explanation depth are compatible with the audience level or expression requirement inferred from the user query.

In some embodiments, ReadabilityScore(v), StyleMatch(v), and AudienceFit(v) may each be normalized to a common range. For example, each component value may be normalized to a range between 0 and 1. The expression style value (S(v)) may be used together with information accuracy (C(v)) to calculate the comprehensive evaluation index (I(v)).

### Internal Feedback Generation Algorithm

In some embodiments, the Response Quality Verification Unit (800) or the Internal Feedback Generator (820) may generate internal feedback based on verified static content. Under a feedback-limited condition, the internal feedback may be used to evaluate a response output and may be transmitted to the Adaptive Optimization Unit (600) for adjustment of a response control parameter.

In some embodiments, the Internal Feedback Generator (820) may classify one or more components associated with a response quality indicator (R) into an information-related aspect and an expression-related aspect. The information-related aspect may be represented by internal information accuracy feedback, and the expression-related aspect may be represented by internal expression style feedback.

In some embodiments, internal information accuracy feedback (f_in_sem) may be determined based on purpose compatibility (PC) and domain compatibility (DC). Purpose compatibility (PC) may represent a degree to which a response output satisfies an intended purpose of a user query. Domain compatibility (DC) may represent a degree to which the response output conforms to terminology, expression norms, or information requirements of a corresponding domain.

For example, internal information accuracy feedback (f_in_sem) may be calculated according to the following formula:

f_in_sem=p_1·PC+p_2·DC
where p_1 and p_2 represent weighting coefficients corresponding to purpose compatibility (PC) and domain compatibility (DC), respectively. In some embodiments, p_1 and p_2 may be normalized so that their sum is equal to 1.

In some embodiments, internal expression style feedback (f_in_style) may be determined based on style consistency (SC) and format coherence (FC). Style consistency (SC) may represent a degree to which an expression style is maintained consistently throughout a response output. Format coherence (FC) may represent a degree to which the structure, arrangement, or format of semantic blocks and verified static content is coherent.

For example, internal expression style feedback (f_in_style) may be calculated according to the following formula:

f_in_style=q_1·SC+q_2·FC
where q_1 and q_2 represent weighting coefficients corresponding to style consistency (SC) and format coherence (FC), respectively. In some embodiments, q_1 and q_2 may be normalized so that their sum is equal to 1.

In some embodiments, the purpose compatibility value (PC) may be used as an information-related feedback component because output purpose compatibility may reflect whether information required by the classified output purpose is sufficiently present and properly emphasized. For example, a comparative response may require comparison criteria and distinction points, a guidance response may require procedural steps and cautions, and a professional-domain response may require domain-specific terminology and information depth.

Accordingly, PC may be operationalized as an information-related criterion, while style consistency or format coherence may be used as expression-related criteria. In some embodiments, internal information-related feedback may also be generated using an average, weighted average, or distribution of block-level information accuracy values C(v), comprehensive evaluation indices I(v), content relevance values, or other block-level evaluation values.

In some embodiments, domain compatibility (DC) may be determined based on whether domain-specific terms, expressions, numerical values, references, or other domain-relevant elements are appropriately included in the response output. For example, the system may extract one or more domain-specific keywords from verified static content and determine a keyword matching rate or semantic correspondence between the verified static content and the response output.

In some embodiments, style consistency (SC) may be determined based on variations in expression style values associated with semantic blocks included in the response output. For example, style consistency (SC) may be calculated based on a standard deviation, mean value, range, or another statistical relationship among expression style values (S(v)) of semantic blocks.

In some embodiments, format coherence (FC) may be determined based on structural completeness of the response output. For example, format coherence (FC) may be evaluated based on whether required slots of a selected output template are satisfied, whether semantic blocks are arranged according to their comprehensive evaluation indices (I(v)), or whether verified static content is integrated using an appropriate connection method.

In some embodiments, verified static content may serve as a reference basis for generating the internal feedback. For example, verified static content may provide comparison criteria for purpose compatibility (PC) or domain compatibility (DC), and may provide an integration context for evaluating style consistency (SC) or format coherence (FC). Accordingly, the system may generate internal feedback based on verified static content even when external user feedback is unavailable.

Through this internal feedback generation process, the system may evaluate information-related and expression-related aspects of a response output and support autonomous response quality improvement based on verified static content.

In some embodiments, internal feedback generated based on verified static content may be used as one source of internal governance feedback, without limiting the internal governance feedback to such internal feedback. For example, internal governance feedback may be generated based on governance reference information including verified static content, response evaluation information, internal feedback information, information indicating an alternative processing operation, information indicating a response control condition, or information associated with a previously formed final user-facing output.

In some embodiments, the internal governance feedback may be used to adjust, determine, or influence one or more response-governance control parameters. The one or more response-governance control parameters may include a content-expression balance control value, a verified-content reliance level, an alternative-processing sensitivity, a response-control state determination sensitivity, a final-output use control intensity, a threshold condition for activating alternative processing, or another parameter used to control subsequent response processing.

### External Feedback Algorithm

In some embodiments, external feedback, or user feedback, may represent evaluation information obtained from outside the system. The external feedback may be generated based on explicit user evaluations, implicit interaction patterns, correction inputs, selection behavior, feedback consistency, user expertise level, usage context, or a combination thereof.

In some embodiments, the external feedback may include an external information-related feedback value (f_out_sem) and an external expression-style feedback value (f_out_style). The external information-related feedback value (f_out_sem) may represent a user-side or external evaluation, preference, or control indication related to information accuracy, factual suitability, domain suitability, content completeness, or a desired relative emphasis on information-related characteristics.

The external expression-style feedback value (f_out_style) may represent a user-side or external evaluation, preference, or control indication related to readability, expression style, clarity, tone, structure, audience suitability, or a desired relative emphasis on expression-related characteristics. In some embodiments, external feedback values may be normalized into feedback-control values compatible with internal feedback values before being combined. For example, the normalization may include min-max scaling, score mapping, range alignment with internal feedback values, or another normalization method.

Accordingly, a higher external feedback value for a given dimension may indicate a positive evaluation of that dimension, a user-indicated need for greater relative emphasis on that dimension in subsequent response processing, or a normalized combination thereof.

In some embodiments, the external feedback may be used together with internal feedback generated based on verified static content. The external feedback may complement internal feedback when user-side evaluation information is available. When external feedback is unavailable, the system may perform autonomous optimization based on internal feedback without requiring the external feedback.

In some embodiments, the external feedback may be provided as an input to a combined feedback algorithm or another feedback processing operation. The combined feedback may then be used to adjust a response control parameter, including a content-expression balance control value (λ), for a later query processing cycle.

### Combined Feedback Algorithm

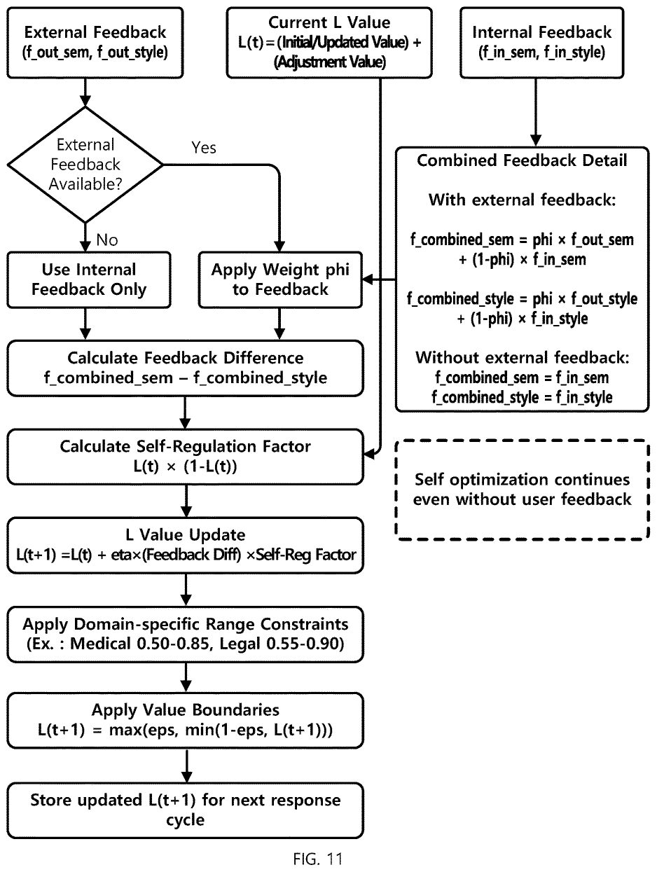

In some embodiments, a combined feedback algorithm may integrate internal feedback and external feedback to generate combined feedback. The system may determine a feedback integration method based on whether external feedback is available. This feedback integration process may provide input for the dynamic adjustment algorithm for the content-expression balance control value illustrated in FIG. 11.

In addition to adjusting a content-expression balance control value, the system may adjust one or more response-governance control parameters using a nonlinear self-regulation mechanism. The response-governance control parameter may be constrained within an allowable control range and may be associated with a target operating range. The target operating range may be a range in which the system is configured to respond more sensitively to internal governance feedback, while one or more boundary regions of the allowable control range may be regions in which the system is configured to reduce adjustment magnitude.

In some embodiments, the nonlinear self-regulation mechanism may use a bounded gain term, a range-dependent adjustment term, a saturation-limiting term, or another nonlinear adjustment function that provides a greater adjustment magnitude within the target operating range than near one or more boundary values of the allowable control range. The nonlinear self-regulation mechanism may thereby reduce over-correction or oscillation of the response-governance control parameter while maintaining adaptive response governance behavior across successive response processing cycles.

In some embodiments, the content-expression balance control value (λ) is one example of the response-governance control parameter. In such embodiments, the nonlinear self-regulation mechanism may include a term based on λ·(1−λ), such that adjustment magnitude is maximized within an intermediate range and reduced near opposite boundary values. In other embodiments, another response-governance control parameter may be adjusted according to a nonlinear adjustment function having similar target-range and boundary-stabilizing behavior.

In some embodiments, the combined feedback may include a combined information accuracy feedback value (f_combined_sem) and a combined expression style feedback value (f_combined_style). The combined information accuracy feedback value (f_combined_sem) may be generated by combining an external information accuracy feedback value (f_out_sem) and an internal information accuracy feedback value (f_in_sem). The combined expression style feedback value (f_combined_style) may be generated by combining an external expression style feedback value (f_out_style) and an internal expression style feedback value (f_in_style).

For example, the combined feedback values may be calculated according to the following formulas:

f_combined_sem=φ·f_out_sem+(1−φ)·f_in_sem

f_combined_style=φ·f_out_style+(1−φ)·f_in_style
where φ represents a feedback weighting value for controlling a relative contribution of external feedback and internal feedback. In some embodiments, φ may have a value between 0 and 1. A higher value of φ may assign greater weight to external feedback, and a lower value of φ may assign greater weight to internal feedback.

In some embodiments, the feedback weighting value φ may be determined according to a domain characteristic, a user expertise level, feedback consistency, feedback availability, a response type, or another implementation condition. For example, in a domain requiring high information reliability, a relatively lower value of φ may be used to increase influence of internal feedback generated based on verified static content. In a domain emphasizing user preference or expression style, a relatively higher value of φ may be used to increase influence of external feedback.

In some embodiments, when external feedback is unavailable, the system may set φ to 0 or otherwise reduce influence of external feedback. In such a case, the combined information accuracy feedback value (f_combined_sem) may correspond to the internal information accuracy feedback value (f_in_sem), and the combined expression style feedback value (f_combined_style) may correspond to the internal expression style feedback value (f_in_style). Accordingly, the system may adjust a content-expression balance control value (λ) based on internal feedback even when external user feedback is unavailable.

In some embodiments, when external feedback is available, the system may generate combined feedback by weighting the external feedback and the internal feedback. The combined feedback may then be transmitted to the Adaptive Optimization Unit (600) and used to adjust the content-expression balance control value (λ) or another response control parameter for a later query processing cycle.

### Self-Regulation Mechanism

In some embodiments, a self-regulation mechanism may be used to adjust one or more response-governance control parameters based on feedback. The one or more response-governance control parameters may affect subsequent response processing operations, including block-level evaluation, verified static content selection, verified static content connection, alternative processing activation, response-control state determination, final-output use control, response reconstruction, or final user-facing output formation. The content-expression balance control value (λ) may be one example of such a response-governance control parameter.

In some embodiments, a self-regulation mechanism may be used to adjust a content-expression balance control value (λ) based on feedback. The content-expression balance control value (λ) may regulate a balance between information accuracy and expression style.

In some embodiments, the system may determine a feedback difference between a combined information accuracy feedback value (f_combined_sem) and a combined expression style feedback value (f_combined_style). When the feedback difference indicates that information accuracy should be emphasized, the content-expression balance control value (λ) may be increased. When the feedback difference indicates that expression style should be emphasized, the content-expression balance control value (λ) may be decreased.

In some embodiments, adjustment of the content-expression balance control value (λ) may be controlled by a learning rate (η) and a nonlinear adjustment term based on λ·(1−λ). The nonlinear adjustment term may have a relatively larger value when λ is in an intermediate range and may have a relatively smaller value when λ approaches a boundary value. Accordingly, the adjustment magnitude may be reduced near boundary values.

In some embodiments, the content-expression balance control value (λ) may be constrained within an allowable range. For example, λ may be constrained within a range of [ε, 1−ε], where ε is a boundary value. In some embodiments, ε may be set according to a domain, implementation requirement, or system configuration. The allowable range may also be combined with a domain-specific allowable range.

In some embodiments, an adjusted value of the content-expression balance control value may be applied to a later query processing cycle rather than modifying a current response output. This may allow a current response output to be generated using a consistent value of λ while allowing subsequent response processing to reflect feedback-based adjustment.

For example, the content-expression balance control value may be updated according to the following formula:

λ_t+1=λ_t+η·(f_combined_sem−f_combined_style)·λ_t·(1−λ_t)
where λ_t represents a current content-expression balance control value, λ_t+1 represents an adjusted content-expression balance control value for a later processing cycle, η represents a learning rate, f_combined_sem represents a combined information accuracy feedback value, and f_combined_style represents a combined expression style feedback value.

In some embodiments, a linear adjustment method may update λ based on a feedback difference without using the nonlinear adjustment term. For comparison, a linear adjustment may be represented as follows:

λ_t+1=λ_t+η·feedback_difference

In an example in which λ_t is 0.7, η is 0.3, and feedback_difference is 0.8, the linear adjustment may produce:

λ_t+1=0.7+0.3·0.8=0.94

In contrast, when the nonlinear adjustment term λ_t·(1−λ_t) is used, the adjustment may be represented as follows:

λ_t+1=λ_t+η·feedback_difference·λ_t·(1−λ_t)

Using the same example values, the adjusted value may be:

λ_t+1=0.7+0.3·0.8·0.7·0.3=0.750

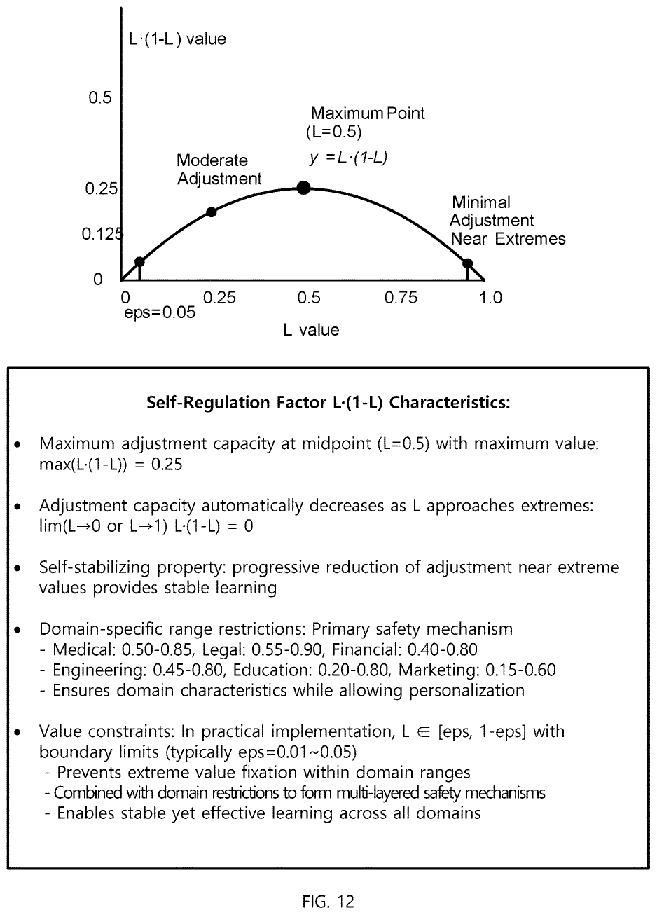

Accordingly, the nonlinear adjustment term may reduce adjustment magnitude when λ approaches a boundary value and may support stable adjustment of the content-expression balance control value over repeated processing cycles. The behavior of the self-regulation mechanism may be as illustrated in FIG. 12.

### Content Connection Method Algorithm

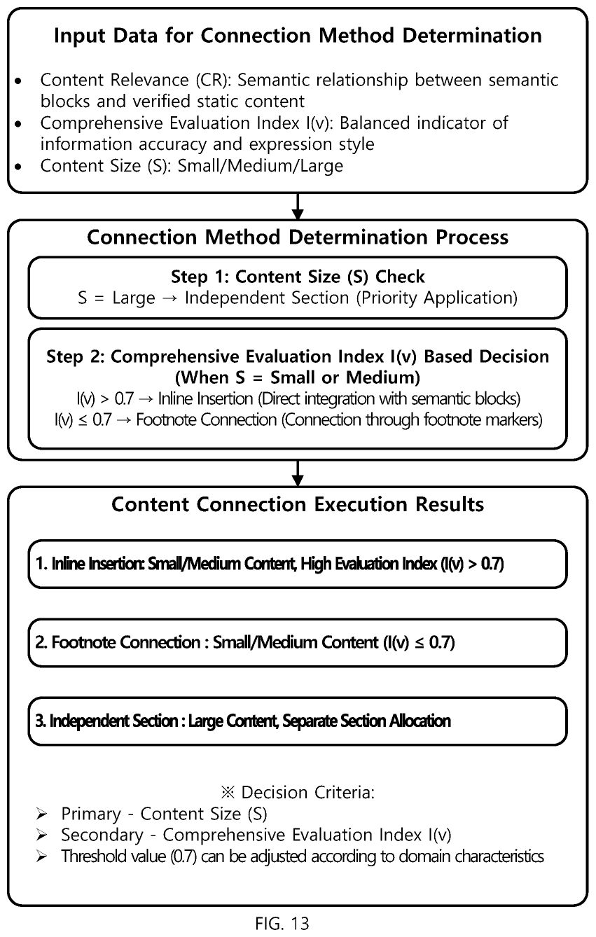

In some embodiments, the Content Matching Unit (500) may perform a content connection method algorithm for determining how verified static content is connected to one or more semantic blocks. This process may be performed as illustrated in FIG. 13.

In some embodiments, the content connection method algorithm may determine a connection method based on content relevance (CR), a comprehensive evaluation index (I(v)), content size, content type, reliability information, domain characteristics, output purpose, or a combination thereof.

The Verified Static Content Repository (540) may store verified static content usable by the system. The verified static content may include expert-reviewed text, tables, formulas, charts, images, guidelines, reference materials, institutional publications, academic materials, standard specifications, official statistics, or other static information. In some embodiments, each content item may include metadata such as source, domain, topic, content type, reliability level, update date, or usage condition.

In some embodiments, verified static content may be used as replacement content, supplementary content, reference content, or evaluation reference content. For example, verified static content may be integrated with a generated response output to improve factual suitability, may be used as a reference basis for internal feedback generation, or may be used to provide visual or structured information such as tables, charts, formulas, diagrams, or other non-textual materials.

In some embodiments, one or more verified static content candidates may be identified based on at least one of a domain, topic, keyword matching, content relevance, metadata, output purpose, or semantic similarity.

Content relevance (CR) may represent a relationship between a semantic block and verified static content. In some embodiments, content relevance (CR) may be calculated according to the following formula:

CR(v, c)=|keywords(v)∩Keywords(c)|/|keywords(v)∪Keywords(c)|
where v represents a semantic block, c represents verified static content, and Keywords() represents a set of keywords extracted from text, metadata, or another content representation.

In some embodiments, keyword extraction may be performed using TF-IDF analysis, named entity recognition, domain-specific dictionaries, semantic analysis, embedding-based analysis, metadata matching, or a combination thereof. Domain-specific weighting may be applied to assign greater importance to keywords or entities that are significant in a corresponding domain.

In some embodiments, the Content Recommender (510) may identify one or more pieces of verified static content corresponding to a semantic block based on content relevance (CR). The Position Determiner (520) may determine a connection method for the identified verified static content based on content relevance (CR), comprehensive evaluation index (I(v)), content size, content type, output purpose, or another implementation condition.

In selecting verified static content for substitution, the system may select the verified static content based on characteristics of the semantic block to be replaced, including the semantic role, output purpose, domain, content relevance, or information-accuracy requirement of the semantic block.

In some embodiments, the verified static content may be selected by matching the verified static content to one or more of the foregoing characteristics of the semantic block to be replaced, rather than being selected solely according to a generic replacement criterion.

Such selection may allow the substituted verified static content to maintain, at least in part, semantic continuity or contextual consistency with the replaced semantic block within the final user-facing output.

In some embodiments, the verified static content is not merely retrieved and appended to a generated response. Instead, the verified static content may be selected in relation to a semantic block to be replaced or supplemented, and the selected verified static content may be integrated, substituted, or arranged according to a response quality indicator, block-level information accuracy, content relevance, output purpose, and a comprehensive evaluation index.

Through this configuration, the system may provide a structured output-control mechanism that operates on individually evaluated semantic blocks and controls contribution of generated response content to a final user-facing output.

In some embodiments, the connection method may include inline insertion, reference-based connection, or separate-section presentation.

Inline insertion may be used when verified static content is suitable for direct integration with a corresponding semantic block. For example, relatively concise verified static content having high relevance to a semantic block may be inserted within or immediately after the semantic block.

Reference-based connection may be used when verified static content is suitable for supplementing a semantic block without interrupting the main flow of the final user-facing output. For example, verified static content may be connected through a footnote, reference mark, citation-like indicator, expandable reference, or another reference-based format.

In some embodiments, the reference-based connection described above may also be referred to as a “footnote connection,” particularly when the verified static content is connected to a semantic block through a footnote, a footnote-like indicator, a reference mark, a citation-like indicator, an expandable reference, or another reference-based format. The terms “reference-based connection” and “footnote connection” may be used interchangeably herein to refer to a non-inline connection of verified static content to a semantic block via a reference-based indicator.

Separate-section presentation may be used when verified static content is relatively large, complex, structured, or suitable for independent presentation. For example, a table, chart, formula, diagram, guideline, detailed reference material, or multi-part explanation may be presented in a separate section associated with the final user-facing output.

In some embodiments, the separate-section presentation described above may also be referred to as an “independent section” or an “independent section connection,” particularly when the verified static content is presented in a section that is structurally separate from the main flow of the final user-facing output. The terms “separate-section presentation,” “independent section,” and “independent section connection” may be used interchangeably herein to refer to presentation of verified static content in a section associated with, but structurally separated from, one or more corresponding semantic blocks.

In some embodiments, a selected verified static content item and a connection method for connecting the selected verified static content item to a semantic block may be determined based on both content relevance and a block-level evaluation value associated with the semantic block. The block-level evaluation value may include information accuracy, a comprehensive evaluation index, output-purpose fitness, domain compatibility, or another value used for evaluating the semantic block.

In some embodiments, the connection method may be determined using the comprehensive evaluation index (I(v)). For example, a semantic block having a relatively high I(v) value may be directly integrated with highly relevant verified static content, while another semantic block may be connected to verified static content through a reference-based connection or separate-section presentation.

In some embodiments, the content mapping table may indicate a relationship among a semantic block, a selected verified static content item, and a determined connection method, and the final user-facing output may be formed based at least in part on the content mapping table.

In one example, threshold values associated with I(v), content size, or content relevance may be used to select among inline insertion, reference-based connection, and separate-section presentation. Such threshold values are exemplary and may be adjusted according to domain, output purpose, reliability requirement, or system configuration. For example, a comprehensive evaluation index threshold of approximately 0.7 may be used to select between inline insertion and reference-based connection of verified static content, although other threshold values may be used.

In some embodiments, reliability information associated with verified static content may be considered when determining the connection method. Verified static content having a relatively high reliability level may be connected more explicitly or placed more prominently in the final user-facing output. In domains requiring high reliability, such as medicine, law, finance, engineering, or another specialized domain, the system may adjust the connection method to increase visibility or traceability of highly reliable verified static content.

The Connection Executor (530) may generate a content mapping table based on the determined connection method. The content mapping table may include information identifying a semantic block, verified static content connected to the semantic block, content relevance (CR), connection method, insertion position, connection priority, reliability information, or other mapping information.

The content mapping table may then be transmitted to the Output Structuring Unit (700), the Response Quality Verification Unit (800), or another module for use in output structuring, response quality verification, internal feedback generation, or alternative processing.

### Output Structuring Algorithm

In some embodiments, the Output Structuring Unit (700) may perform an output structuring algorithm to generate a structured response output. The output structuring algorithm may use, as inputs, one or more semantic blocks, comprehensive evaluation indices (I(v)) associated with the semantic blocks, an output template selected by the Output Purpose Determination Unit (400), and a content mapping table generated by the Content Matching Unit (500).

In some embodiments, the output structuring algorithm may include block placement, verified static content integration, and final output preparation.

In a block placement operation, the Block Placement Optimizer (710) may determine placement of one or more semantic blocks within an output template. The Block Placement Optimizer (710) may evaluate suitability of each semantic block for one or more template slots based on content relevance (CR), semantic similarity, output purpose, slot-specific characteristics, the comprehensive evaluation index (I(v)), or a combination thereof.

In some embodiments, semantic similarity may be calculated using a SemanticSimilarity() function or another semantic relationship calculation method. Based on the calculated suitability, each semantic block may be assigned to a corresponding template slot. Within a template slot, semantic blocks may be arranged according to their comprehensive evaluation indices (I(v)), semantic sequence, content relevance, logical dependency, or another ordering condition.

When a number of semantic blocks exceeds a capacity associated with a template slot, the Block Placement Optimizer (710) may select one or more semantic blocks based on the comprehensive evaluation index (I(v)), content relevance, output purpose fitness, or another priority criterion.

In a verified static content integration operation, the Verified Static Content Integrator (720) may integrate verified static content with one or more semantic blocks according to the content mapping table. The integration method may be determined based on a connection method specified in the content mapping table. For example, verified static content may be directly inserted within or near a corresponding semantic block, connected through a reference-based connection, or presented in a separate section.

In some embodiments, the Verified Static Content Integrator (720) may preserve a semantic relationship between a generated response portion and corresponding verified static content. The Verified Static Content Integrator (720) may also insert source information, metadata, explanatory labels, transition phrases, or other connective elements to improve coherence, traceability, or readability of the structured response output.

In a final output preparation operation, the Output Preparer (730) may compose the arranged semantic blocks and integrated verified static content into a final output format. The Output Preparer (730) may apply template constraints, transition phrases, formatting rules, block count limitations, information accuracy requirements, output-purpose requirements, or domain-specific presentation rules.

In some embodiments, the Output Preparer (730) may validate whether the structured response output satisfies one or more template conditions. The template conditions may include slot fulfillment, required information coverage, structural coherence, format consistency, or another output condition. The prepared structured response output may then be transmitted to the Response Quality Verification Unit (800), the Output Provision Unit (900), or another module.

Through the output structuring algorithm, the system may arrange generated response content and verified static content according to semantic relevance, information importance, output purpose, and domain characteristics.

### Response Quality Indicator (R) Calculation Algorithm

In some embodiments, the Response Quality Verification Unit (800) may calculate a response quality indicator (R) for a response output or a structured response output. The response quality indicator (R) may represent response-level quality of the response output and may be used to determine whether substitution, alternative processing, or another response-control operation is required.

In some embodiments, the response quality indicator (R) may be determined based on one or more response-level components, including style consistency (SC), purpose compatibility (PC), format coherence (FC), and domain compatibility (DC).

For example, the response quality indicator (R) may be calculated according to the following formula:

R=w_1·SC+w_2·PC+w_3·FC+w_4·DC
where SC represents style consistency, PC represents purpose compatibility, FC represents format coherence, DC represents domain compatibility, and w_1, w_2, w_3, and w_4 represent weighting coefficients corresponding to the respective components.

In some embodiments, the weighting coefficients w_1, w_2, w_3, and w_4 may be determined based on at least one of a domain, output purpose, response type, reliability requirement, service policy, user query characteristic, or implementation constraint. The weighting coefficients may be adjusted according to domain-specific reliability requirements or other implementation requirements. In some embodiments, SC, PC, FC, and DC may each be normalized to a common range before weighted combination.

In some embodiments, when the response quality indicator (R) does not satisfy one or more predefined threshold conditions, the system may perform substitution, alternative processing, or another response-control operation. For example, the Alternative Processor (830) may replace one or more deficient semantic blocks, reconstruct a response output around one or more selected semantic blocks, or form a final user-facing output using verified static content.

The response quality indicator (R) may be distinguished from the comprehensive evaluation index (I(v)). The response quality indicator (R) may be used to evaluate a response output at a response level, whereas the comprehensive evaluation index (I(v)) may be used to evaluate a semantic block v at a block level. Accordingly, the response quality indicator (R) may be used to determine whether response-level control is required, and the comprehensive evaluation index (I(v)) may be used to determine block-level placement, content connection, substitution, preservation, or reconstruction.

### Alternative Processing Algorithm

In some embodiments, the Alternative Processor (830) may perform an alternative processing algorithm when a response quality condition is not satisfied. The response quality condition may be determined based on a response quality indicator (R), one or more threshold values, information accuracy associated with one or more semantic blocks, a comprehensive evaluation index (I(v)), or a combination thereof.

In some embodiments, the Response Quality Verification Unit (800), the Alternative Processor (830), or another response-control module may dynamically apply differential threshold values (T) to one or more semantic blocks based on an output purpose classified by the system.

In a specialized domain, such as medicine, law, finance, engineering, or another high-reliability domain, information requiring relatively higher precision may be assigned a more stringent reliability threshold. Conversely, semantic blocks associated with general informational content may be governed by a relatively lower threshold. By applying differential thresholds, the system may selectively process one or more deficient semantic blocks without replacing or suppressing an entire response output.

In some embodiments, the alternative processing algorithm may use both the response quality indicator (R) and the comprehensive evaluation index (I(v)). The response quality indicator (R) may be used to determine whether response-level control is required, and the comprehensive evaluation index (I(v)) may be used to determine which semantic block is preserved, replaced, reconstructed, or otherwise processed.

In certain embodiments, the response quality indicator (R) is used as a criterion for alternative processing of the response output. In addition, at least one of information accuracy and a block-level evaluation value associated with one or more semantic blocks may be used in determining selective replacement of low-quality semantic blocks, structural rearrangement of response content, or substitution with verified static content.

In some embodiments, the alternative processing algorithm may operate through a hierarchical control procedure. In this procedure, a response-level evaluation may first be performed for a response output to determine whether the response output satisfies a response quality condition. The response-level evaluation may include calculating a response quality indicator (R) for the response output. When the response quality condition is not satisfied, the system may activate an alternative processing mode for the response output.

After the alternative processing mode is activated, the system may perform a block-level evaluation of one or more semantic blocks included in the response output. The block-level evaluation may include determining information accuracy, a comprehensive evaluation index, content relevance, output purpose fitness, or another block-level evaluation value associated with the semantic blocks. The block-level evaluation may be used to select at least one semantic block to be replaced, preserved, rearranged, or used as a basis for reconstruction.

In some embodiments, the response-level evaluation and the block-level evaluation may operate at different control levels. The response-level evaluation may determine whether alternative processing is required for the response output, while the block-level evaluation may determine which semantic block is to be processed after the alternative processing mode has been activated. This separation may allow the system to avoid replacing an entire response output when only a portion of the response output is deficient.

In some embodiments, when a semantic block is selected for replacement, the selected semantic block, or a portion thereof, may be omitted from, excluded from, or not used in forming the final user-facing output. A portion of the final user-facing output corresponding to the selected semantic block may instead be formed using pre-validated verified static content. The pre-validated verified static content may be selected based on at least one of a semantic role, an output purpose, a domain, content relevance, or an information-accuracy requirement of the selected semantic block.

In some embodiments, the alternative processing algorithm may preserve one or more non-deficient semantic blocks while replacing one or more deficient semantic blocks. In this manner, the system may maintain useful portions of a generated response output while preventing a deficient portion from being used in the final user-facing output. The final user-facing output may therefore include one or more preserved generated semantic blocks and one or more portions formed using pre-validated verified static content.

In some embodiments, the alternative processing algorithm may reconstruct a response output around one or more selected semantic blocks. For example, semantic blocks having relatively higher information accuracy, higher comprehensive evaluation indices, or higher content relevance may be preserved as core blocks, while one or more deficient semantic blocks may be omitted, replaced, rearranged, or supplemented using pre-validated verified static content. The reconstructed output may then be arranged according to an output template or a content mapping table.

In some embodiments, the alternative processing algorithm may form a final user-facing output using pre-validated verified static content when the response quality condition indicates a higher degree of deficiency. In such a case, at least a portion of the generated response output may be prevented from contributing to the final user-facing output, and the final user-facing output may be formed using verified static content corresponding to the user query, output purpose, domain, or semantic role of the deficient content.

In some embodiments, the alternative processing algorithm may be performed in the current response cycle. Accordingly, even when an initially generated response output does not satisfy a response quality condition, the system may still provide a final user-facing output by selectively replacing, reconstructing, or forming at least a portion of the output using pre-validated verified static content. In contrast, feedback-based adjustment of a content-expression balance control value may be applied to a later query processing cycle.

In some embodiments, alternative processing may be performed at different deficiency levels.

For a first deficiency level, the Alternative Processor (830) may perform individual block replacement by replacing one or more deficient semantic blocks with verified static content while preserving one or more non-deficient semantic blocks.

For a second deficiency level, the Alternative Processor (830) may perform core block reconstruction by reconstructing a response output around one or more selected semantic blocks.

For a third deficiency level, the Alternative Processor (830) may form a final user-facing output using verified static content.

For the avoidance of doubt, preventing at least a portion of a generated response output from contributing to a final user-facing output does not require operating-system-level process termination. In some embodiments, the identified portion may be omitted from, excluded from, or not used in forming the final user-facing output, and a corresponding portion of the final user-facing output may be formed using verified static content.

In some embodiments, the Alternative Processor (830) may determine verified static content for alternative processing based on relevance between a user query, a semantic block, and verified static content. The relevance determination may consider keyword matching, semantic similarity, content relevance (CR), domain fitness, output purpose, reliability information, or a combination thereof.

In some embodiments, the final user-facing output generated through alternative processing may include metadata, source information, labels, or other traceability information indicating that verified static content has been used or that alternative processing has been performed.

In some embodiments, the metadata, source information, labels, or traceability information may indicate at least one of a semantic block for which alternative processing has been performed, a verified static content item used in forming a corresponding portion of the final user-facing output, a connection method between the semantic block and the verified static content, a replacement or supplementation status, or a response-control state associated with the alternative processing.

In some embodiments, the metadata, source information, labels, traceability information, or other output artifacts may serve as externally observable governance information indicating that an output-governance operation has been performed in forming the final user-facing output. The externally observable governance information may indicate, for example, use of verified static content, performance of alternative processing, a response-control state, omission, exclusion, or non-use of generated response content, substitution or reconstruction of response content, or another final-output formation operation.

In some embodiments, the final user-facing output may include an externally observable output artifact resulting from use of the verified static content. The externally observable output artifact may include a structural change in the final user-facing output, a separate verified-content section, a reference-based connection, a source indication, a replacement indication, a traceability label, or metadata associated with a portion of the final user-facing output formed using verified static content.

In some embodiments, the externally observable output artifact may be provided in a user-visible form, a system-readable form, or both. For example, the output artifact may be displayed in the final user-facing output, included in metadata associated with the final user-facing output, or provided to another system for logging, audit, traceability, quality verification, or compliance support.

Such observability may result from a shift in the response format from probabilistic generated content to verified static content within the current response cycle, as the resulting change may be reflected in the final user-facing output artifact.

### Multi-Threshold Alternative Processing Example

In some embodiments, the response quality condition may correspond to one of a plurality of threshold ranges. Each threshold range may correspond to a different alternative processing operation, including individual block replacement, core block reconstruction, or formation of a final user-facing output using verified static content. In some embodiments, for example, a first threshold value may be approximately 0.7·T and a second threshold value may be approximately 0.4·T, though such values are exemplary and may be adjusted according to domain characteristics, reliability requirements, or implementation conditions.

These threshold ranges may provide an illustrative structured implementation of multi-level alternative processing.

### Feedback Learning System Algorithm

In some embodiments, the Feedback Learning System (954) may perform a feedback learning system algorithm in the Common Service Layer (950). The feedback learning system algorithm may aggregate feedback collected across multiple sessions and may support long-term adjustment of domain-specific settings.

In some embodiments, the feedback learning system algorithm may update an initial value, allowable range, or other domain-specific setting of a content-expression balance control value (λ). This system-level adjustment may be performed separately from adjustment of λ for an individual query processing cycle.

In some embodiments, the feedback learning system algorithm may include multi-session feedback collection, statistical pattern analysis, and domain parameter update.

In a multi-session feedback collection operation, internal feedback, external feedback, combined feedback, response quality indicator (R), final content-expression balance control value, domain information, output purpose information, or other session-related metadata may be collected across multiple sessions. In some embodiments, the collected feedback may be anonymized, aggregated, or otherwise processed to reduce association with individual users.

In a statistical pattern analysis operation, accumulated feedback data may be analyzed by domain, output purpose, response type, or another classification condition. The analysis may identify a distribution, trend, or representative value associated with the content-expression balance control value (λ).

For example, a domain-specific representative value may be calculated according to the following formula:

λ_representative_field=Σ(λ_final·weight)/Σ(weight)
where λ_representative_field represents a representative content-expression balance control value for a domain, λ_final represents a content-expression balance control value obtained at an end of a session or processing cycle, and weight represents a weighting value assigned to the corresponding session.

In some embodiments, when external feedback is available, the weighting value may be determined based on the response quality indicator (R) and a difference between an external information accuracy feedback value and an external expression style feedback value. For example, the weighting value may be determined according to the following formula:

weight=R·(1+|f_out_sem−f_out_style|)
where f_out_sem represents an external information accuracy feedback value and f_out_style represents an external expression style feedback value.

In some embodiments, when external feedback is unavailable, the weighting value may be determined based on the response quality indicator (R). For example, the weighting value may be determined according to the following formula:

weight=R

In this manner, sessions having relatively high response quality may have a greater influence on domain-level adjustment. When external feedback is available, sessions indicating a stronger external preference between information accuracy and expression style may also have a greater influence. Sessions without external feedback may still contribute to domain-level adjustment based on the response quality indicator (R).

In a domain parameter update operation, the Feedback Learning System (954) may update an initial value, allowable range, or another domain-specific setting of the content-expression balance control value (λ). In some embodiments, the update may be performed after a predetermined amount of feedback data is accumulated, after a time interval, or when a statistical confidence condition is satisfied. The update may be performed gradually to reduce abrupt changes from previous settings.

In some embodiments, the system-level adjustment described above may also be referred to as a “continuous update” of an initial value, an allowable range, or another domain-specific setting of the content-expression balance control value (λ), in the sense that the update is performed in an ongoing or recurring manner across multiple sessions when a predetermined amount of feedback data is accumulated, a time interval has elapsed, a statistical confidence condition is satisfied, or another update trigger condition is met. The term “continuous” does not require instantaneous or uninterrupted modification, and may refer to recurring, session-spanning updating of domain-specific settings over repeated use of the system.

Through the feedback learning system algorithm, the system may adjust domain-specific settings based on accumulated feedback patterns while maintaining query-level adjustment and internal-feedback-based optimization in individual response cycles.

### Adaptive Optimization Configuration

In some embodiments, the system may determine an initial value or an allowable range of a content-expression balance control value (λ) according to a domain associated with a user query. The domain may include, for example, a medical domain, a legal domain, a financial domain, an engineering domain, an educational domain, a marketing domain, or another application domain.

In some embodiments, the initial value or allowable range of the content-expression balance control value (λ) may be determined based on one or more domain characteristics, including information accuracy requirements, structural clarity requirements, visual representation requirements, expertise level, regulatory requirements, reliability requirements, expression flexibility, or a combination thereof.

For example, a medical domain or a legal domain may use a relatively higher range of λ to place greater emphasis on information accuracy and terminology precision. An educational domain may use an intermediate range of λ to balance information accuracy and understandability. A marketing domain or another expression-oriented domain may use a relatively lower range of λ to place greater emphasis on expression style or persuasive effect.

In some embodiments, exemplary allowable ranges may be set as follows: a medical domain may use a range of 0.50 to 0.85, a legal domain may use a range of 0.55 to 0.90, a financial domain may use a range of 0.40 to 0.80, an engineering domain may use a range of 0.45 to 0.80, an educational domain may use a range of 0.20 to 0.80, and a marketing domain may use a range of 0.15 to 0.60. These ranges are exemplary, and other ranges may be used according to implementation requirements, service policies, target users, or application environments.

In some embodiments, the domain-specific allowable range may constrain adjustment of the content-expression balance control value (λ). When a user query is received, the system may identify a domain associated with the user query and load an initial value or allowable range from a Domain-Specific Value Repository (650). The system may apply a query customization adjustment value, internal feedback, external feedback, combined feedback, or another adjustment factor to the content-expression balance control value (λ), while constraining the adjusted value within the corresponding allowable range.

In some embodiments, the domain-specific allowable range may operate as a constraint or clipping range that prevents the content-expression balance control value (λ) from moving outside a range appropriate for a corresponding domain. This domain-specific range constraint is distinct from the nonlinear self-regulation factor λ·(1−λ). The nonlinear self-regulation factor may reduce an adjustment magnitude as λ approaches universal boundary values of an overall allowable range, such as 0 or 1, or practical boundary values such as ε and 1−ε.

By contrast, the domain-specific allowable range may limit or clip an adjusted λ value to maintain domain-appropriate response characteristics even when the nonlinear self-regulation factor itself does not decrease near a domain-specific boundary. Through the combined use of the nonlinear self-regulation factor and the domain-specific allowable range, the system may reduce excessive variation of the content-expression balance control value (λ) while maintaining domain-appropriate response characteristics and reflecting query-specific or feedback-based adjustments.

### Weight Parameters in the System

In some embodiments, the system may use a plurality of weight parameters for controlling response processing, evaluation, structuring, feedback processing, or adaptive optimization. The weight parameters may include response control parameters and calculation parameters.

In some embodiments, a content-expression balance control value (λ) may be used as a response control parameter. The content-expression balance control value (λ) may regulate a balance between information accuracy and expression style. The content-expression balance control value (λ) may have a value within a predefined range, such as a range between 0 and 1, and may be initialized according to a domain, output purpose, service policy, or another implementation condition.

In some embodiments, the content-expression balance control value (λ) may be adjusted based on internal feedback, external feedback, combined feedback, a query customization adjustment value, or a combination thereof. A learning rate (η) may control an adjustment magnitude or adjustment speed of the content-expression balance control value (λ). In certain embodiments, the content-expression balance control value (λ) may be adjusted through the self-regulation mechanism described above.

In some embodiments, calculation parameters may be used for information accuracy calculation, response quality evaluation, feedback generation, or feedback integration. For example, information accuracy calculation may use weighting coefficients α, β, and γ corresponding to intrinsic significance (CS), contextual connectivity (CC), and output purpose fitness (CO), respectively. Information accuracy calculation may also use coefficients such as k_kd, k_ed, and k_ir for sub-elements of intrinsic significance, and coefficients such as c_ls, c_ss, and c_km for sub-elements of output purpose fitness.

In some embodiments, response quality evaluation may use weighting coefficients w_1, w_2, w_3, and w_4 corresponding to style consistency (SC), purpose compatibility (PC), format coherence (FC), and domain compatibility (DC), respectively. Internal feedback generation may use weighting coefficients p_1, p_2, q_1, and q_2. Feedback integration may use a feedback weighting value φ for controlling a relative contribution of internal feedback and external feedback.

In some embodiments, one or more weight parameters may be preset for a specific domain, output purpose, response type, service environment, or implementation configuration. In other embodiments, one or more weight parameters may be adjusted during operation based on feedback, accumulated session data, system requirements, or application environments.

Through use of these weight parameters, the system may control relationships among information accuracy, expression style, output purpose, domain compatibility, response quality, and feedback-based adjustment.

### Integrated Operation of Algorithms

In some embodiments, the algorithms described above may operate in combination to control a balance between information accuracy and expression style, integrate verified static content with generated response content, and structure a final user-facing output according to an output purpose or domain characteristic.

In some embodiments, the internal feedback generation algorithm and the self-regulation mechanism may operate together. Internal feedback generated based on verified static content may be used to adjust a content-expression balance control value (λ), and the self-regulation mechanism may control an adjustment magnitude of the content-expression balance control value (λ). In this manner, the system may support feedback-based adjustment while reducing excessive variation of response control parameters.

In some embodiments, verified static content may serve multiple functions. The verified static content may be used as replacement content, supplementary content, reference content, or a reference basis for internal feedback generation. The verified static content may also be used in response quality verification, alternative processing, or final output structuring.

In some embodiments, a comprehensive evaluation index (I(v)) may serve as a block-level decision criterion. The comprehensive evaluation index (I(v)) may be used by the Content Matching Unit (500), the Output Structuring Unit (700), and the Alternative Processor (830). For example, the comprehensive evaluation index (I(v)) may be used to determine a verified static content connection method, semantic block placement, semantic block preservation, semantic block replacement, or response reconstruction.

In some embodiments, different implementation stages may use different combinations of the algorithms. An optimal implementation may perform query customization, semantic block evaluation, verified static content connection, output structuring, response quality verification, internal feedback generation, and adaptive optimization. An extended implementation may further perform alternative processing in a current response cycle when a response quality condition is not satisfied. A complete implementation may further perform multi-session feedback learning or long-term adjustment of domain-specific settings.

Through the integrated operation of the algorithms, the system may provide structured response outputs using semantic block evaluation, verified static content integration, response-level quality evaluation, and feedback-based adjustment. The following examples describe domain-specific implementations in which the algorithms may be applied according to implementation stage, domain characteristic, output purpose, and response control parameters.

### Domain-Specific Implementations

### Medical Information Implementation

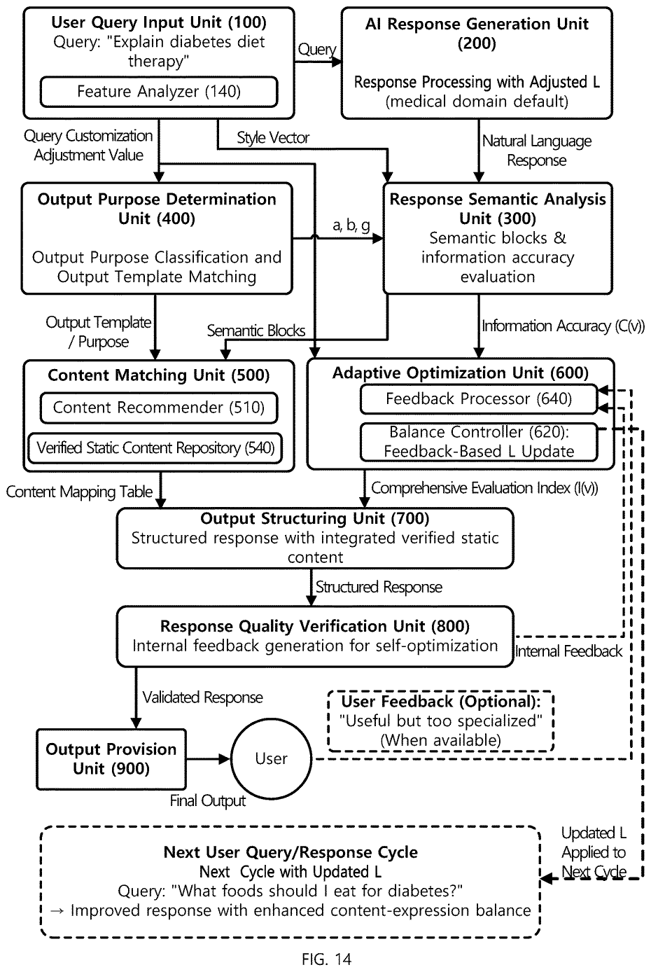

In some embodiments, the system may be applied to a medical information response environment. For example, as illustrated in FIG. 14, a user query may include a request such as “Explain diabetes diet therapy.”

In this example, the system may identify a medical domain based on terms included in the user query, such as “diabetes,” “diet therapy,” or related medical-dietary terminology.

In one example, the Adaptive Optimization Unit (600) may apply the query customization adjustment value to a medical-domain base value of the content-expression balance control value (λ). For example, a medical-domain base value may be adjusted from 0.70 to 0.73 and constrained within an allowable medical-domain range, such as 0.50 to 0.85. These numerical values are exemplary and may be changed according to implementation requirements.

The AI Response Generation Unit (200) may generate an initial response output for the user query. The Response Semantic Analysis Unit (300) may divide the initial response output into semantic blocks and evaluate information accuracy for one or more of the semantic blocks. For example, a semantic block describing carbohydrate control for diabetic patients or meal planning principles may receive a relatively high information accuracy value when it corresponds to verified medical information.

The Output Purpose Determination Unit (400) may select a medical information explanation template. In some embodiments, the template may include sections such as disease definition, causes, management principles, detailed guidelines, precautions, or another medical-information section. The Content Matching Unit (500) may identify verified static content related to diabetes diet therapy, such as medical guidelines, nutrition tables, dietary recommendations, or diagrams.

The Output Structuring Unit (700) may integrate verified static content with one or more semantic blocks according to a content mapping table. For example, verified static content related to carbohydrate calculation methods, nutrient-specific recommended amounts, or hypoglycemia coping methods may be connected to corresponding semantic blocks through inline insertion, reference-based connection, or separate-section presentation.

In some embodiments, the system may supplement information that is absent or insufficient in the initially generated response output. For example, when an initially generated response output does not include sufficient information regarding hypoglycemia coping methods, the system may connect verified static content corresponding to that topic and include the connected information in the final user-facing output.

The Response Quality Verification Unit (800) may generate internal feedback based on verified static content. For example, the Internal Feedback Generator (820) may calculate an internal information accuracy feedback value (f_in_sem) and an internal expression style feedback value (f_in_style). In one example, f_in_sem may be 0.85 and f_in_style may be 0.78. These values are illustrative.

In some embodiments, the internal feedback may be generated by comparing characteristics of a response output with characteristics of verified medical content. For example, purpose compatibility or domain compatibility may be evaluated based on terminology density, entity density, guideline correspondence, domain-specific keywords, or another medically relevant feature. Style consistency or format coherence may be evaluated based on expression style values, template slot satisfaction, or arrangement of verified static content.

The Adaptive Optimization Unit (600) may adjust the content-expression balance control value (λ) based on the internal feedback. For example, a difference between f_in_sem and f_in_style may be used with the self-regulation mechanism described above. An adjusted value may be stored for use in a later query processing cycle rather than modifying the current response output.

In some embodiments, when external user feedback is provided, the system may combine the external feedback with the internal feedback. For example, when a user provides feedback indicating that the information is useful but too specialized, the system may generate an external information accuracy feedback value (f_out_sem) and an external expression style feedback value (f_out_style). In this example, the external feedback may indicate that the generated response is generally useful from an information perspective, but that a greater relative emphasis on expression style, readability, or reduced expression complexity is desired.

The combined feedback algorithm may then determine combined feedback using a feedback weighting value (φ).

For example, when f_out_sem is 0.60, f_out_style is 0.90, f_in_sem is 0.85, f_in_style is 0.78, and φ is 0.7, the system may calculate combined feedback values as follows:

f_combined_sem=0.7·0.60+0.3·0.85=0.675

f_combined_style=0.7·0.90+0.3·0.78=0.864

Based on the combined feedback values, the system may adjust the content-expression balance control value (λ) for a later query processing cycle. In this example, the feedback difference f_combined_sem−f_combined_style is negative, and the content-expression balance control value (λ) may be adjusted downward according to the self-regulation mechanism described above. Accordingly, the system may maintain verified medical accuracy while increasing the relative influence of expression style in a later query processing cycle, thereby reducing expression complexity.

In some embodiments, the adjusted content-expression balance control value (λ) may be applied to a subsequent query received in a later query processing cycle. For example, when a subsequent user query, such as “What foods should I eat for diabetes?”, is received in a later query processing cycle following the initial query “Explain diabetes diet therapy,” the system may generate a response output reflecting an adjusted content-expression balance based on the adjusted content-expression balance control value (λ), as illustrated in FIG. 14.

These numerical values and adjustment directions are illustrative and may vary according to domain settings, feedback weighting, and implementation requirements.

Through this example, the system may provide a medical-domain response by combining semantic block analysis, verified static content integration, internal feedback generation, external feedback integration, and feedback-based adjustment of the content-expression balance control value (λ).

The example may be implemented using the optimal implementation configuration including the User Query Input Unit (100), AI Response Generation Unit (200), Response Semantic Analysis Unit (300), Output Purpose Determination Unit (400), Content Matching Unit (500), Adaptive Optimization Unit (600), Output Structuring Unit (700), Response Quality Verification Unit (800), and Output Provision Unit (900).

### Legal Document Analysis Implementation

In some embodiments, the system may be applied to a legal document analysis environment. This example may correspond to an extended implementation in which the Alternative Processor (830) is used. For example, a user query may include a request such as “Please analyze the major risk factors of the contract.”

In this example, the system may identify a legal domain based on terms included in the user query, such as “contract,” “risk,” or “analysis.” The User Query Input Unit (100) may analyze the query and generate a style vector representing query intent, writing style, response nature, or another query characteristic. The Feature Analyzer (140) may generate a query customization adjustment value based on the style vector or related analysis results.

In one example, the Adaptive Optimization Unit (600) may apply the query customization adjustment value to a legal-domain base value of the content-expression balance control value (λ). For example, a legal-domain base value may be adjusted from 0.75 to 0.78 and constrained within an allowable legal-domain range, such as 0.55 to 0.90. These numerical values are exemplary and may be changed according to implementation requirements.

The AI Response Generation Unit (200) may generate an initial response output for the user query. The Response Semantic Analysis Unit (300) may divide the initial response output into semantic blocks and evaluate information accuracy for one or more of the semantic blocks. For example, a semantic block describing a liability limitation clause, a force majeure clause, an indemnity clause, a termination clause, or another contractual provision may be evaluated based on legal terminology, clause relationship, legal effect, or relevance to the requested risk analysis.

The Output Purpose Determination Unit (400) may select a legal risk analysis template. In some embodiments, the template may include sections such as issue identification, relevant clause summary, legal risk factor, precedent or statutory reference, practical implication, and recommended review point. The Content Matching Unit (500) may identify verified static content related to legal analysis, such as statutory provisions, case summaries, contract review guidelines, model clauses, regulatory materials, or other legal reference materials.

The Output Structuring Unit (700) may integrate verified static content with one or more semantic blocks according to a content mapping table. For example, a summary of related precedents or statutory provisions may be connected to a semantic block describing a liability limitation clause through inline insertion, reference-based connection, or separate-section presentation.

The Response Quality Verification Unit (800) may calculate a response quality indicator (R) for the structured response output. In some embodiments, the response quality indicator (R) may be calculated based on style consistency, purpose compatibility, format coherence, domain compatibility, or another response-level factor.

When a response quality condition is not satisfied, the Alternative Processor (830) may perform alternative processing in a current response cycle. For example, when a response quality indicator (R) is below a threshold condition associated with the legal domain, the Alternative Processor (830) may evaluate one or more semantic blocks based on the comprehensive evaluation index (I(v)), information accuracy (C(v)), content relevance (CR), or another block-level evaluation value.

In some embodiments, the Alternative Processor (830) may replace one or more deficient semantic blocks with verified static content while preserving one or more non-deficient semantic blocks. For example, a semantic block having a relatively high comprehensive evaluation index (I(v)) may be preserved, while a semantic block having a relatively low comprehensive evaluation index (I(v)) may be replaced or supplemented with verified legal content.

In some embodiments, the Alternative Processor (830) may reconstruct a response output around one or more selected semantic blocks. For example, semantic blocks having relatively higher comprehensive evaluation indices (I(v)) may be used as core blocks, while other semantic blocks may be replaced, supplemented, rearranged, or reconstructed using verified legal content.

In some embodiments, the Alternative Processor (830) may form a final user-facing output using verified static content. In such a case, at least a portion of an initially generated response output may be prevented from contributing to the final user-facing output, and the final user-facing output may be composed using verified static content related to the user query. In some embodiments, when no verified static content satisfying a relevance threshold, domain requirement, output-purpose requirement, or verification condition is available for the user query, the system may perform a controlled fallback operation.

The controlled fallback operation may include outputting a notice indicating that sufficient verified static content is not available, requesting additional information from the user, providing a limited generic response that does not rely on unverified generated content, suppressing the deficient generated response output, escalating the query for human or expert review, or recording the unavailability condition as response evaluation information for subsequent response processing.

The final user-facing output may be organized according to the selected legal risk analysis template. Legal information blocks may be arranged according to their comprehensive evaluation indices (I(v)), logical dependency, issue priority, legal relevance, or another ordering condition. Related precedents, statutory provisions, contract clauses, or review guidelines may be integrated using a connection method determined by the Content Matching Unit (500).

In some embodiments, the Response Quality Verification Unit (800) may generate internal feedback based on verified legal content. For example, the Internal Feedback Generator (820) may calculate an internal information accuracy feedback value (f_in_sem) and an internal expression style feedback value (f_in_style). The Adaptive Optimization Unit (600) may use the internal feedback to adjust the content-expression balance control value (λ) for a later query processing cycle.

In some embodiments, when external user feedback is provided, the system may combine the external feedback with the internal feedback. For example, when a user indicates that precedent citation is useful but that more specific risk assessment is needed, the system may generate external feedback values and combine them with internal feedback values. The resulting combined feedback may be used to adjust the content-expression balance control value (λ) in a direction that maintains legal accuracy while modifying practical analysis depth or expression style.

Through this example, the system may provide a legal-domain response by combining semantic block analysis, verified legal content integration, response-level quality verification, current-cycle alternative processing, and feedback-based adjustment of a content-expression balance control value (λ). The example may be implemented using the extended implementation configuration including the Alternative Processor (830).

### Financial Report Implementation

In some embodiments, the system may be applied to a financial report summarization environment. This example may correspond to a complete implementation in which the Common Service Layer (950) and the Feedback Learning System (954) are used. For example, a user query may include a request such as “Briefly summarize the market trends for Q1 2024 in an easily understandable way.”

In this example, the system may identify a financial domain based on terms or context included in the user query, such as “market trends,” “Q1 2024,” “sector performance,” or “financial indicators.” The User Query Input Unit (100) may analyze the query and generate a style vector representing query intent, writing style, response nature, or another query characteristic.

In one example, the Feature Analyzer (140) may detect a query-specific requirement such as “easily” or “briefly” and generate a query customization adjustment value. The Adaptive Optimization Unit (600) may apply the query customization adjustment value to a financial-domain base value of the content-expression balance control value (λ). For example, a financial-domain base value may be adjusted from 0.65 to 0.62 and constrained within an allowable financial-domain range, such as 0.40 to 0.80. These numerical values are exemplary and may be changed according to implementation requirements.

The AI Response Generation Unit (200) may generate an initial response output for the user query. The Response Semantic Analysis Unit (300) may divide the initial response output into semantic blocks and evaluate information accuracy for one or more of the semantic blocks. For example, a semantic block describing a percentage change in a technology sector, an interest rate change, an inflation indicator, a market index movement, or another financial metric may be evaluated based on numerical accuracy, temporal context, source reliability, or relevance to the requested summary.

The Output Purpose Determination Unit (400) may select a financial summary template. In some embodiments, the template may include sections such as market overview, key indicators, sector performance, major events, risk factors, and outlook. The Content Matching Unit (500) may identify verified static content related to financial information, such as market data tables, official statistics, regulatory materials, economic indicators, sector reports, or chart data.

The Output Structuring Unit (700) may integrate verified static content with one or more semantic blocks according to a content mapping table. For example, numerical data may be integrated with textual explanation, and chart data or table data may be presented in a separate section or connected through a reference-based connection. In some embodiments, verified static content may be used to provide temporal context, source traceability, or numerical consistency for the financial summary.

The Response Quality Verification Unit (800) may evaluate the structured response output based on a response quality indicator (R). In some embodiments, the response quality indicator (R) may consider style consistency, purpose compatibility, format coherence, domain compatibility, numerical consistency, or another response-level factor. When a response quality condition is not satisfied, the Alternative Processor (830) may replace, supplement, or reconstruct one or more semantic blocks using verified static content.

In the complete implementation, the Feedback Learning System (954) may aggregate feedback across multiple sessions and support long-term adjustment of domain-specific settings. For example, the Feedback Learning System (954) may analyze accumulated feedback in the financial domain and determine that users frequently prefer visual representation, concise summaries, or a particular balance between numerical accuracy and readability.

Based on accumulated feedback patterns, the Feedback Learning System (954) may update a financial-domain initial value or allowable range of the content-expression balance control value (λ). For example, an initial value may be adjusted from 0.65 to 0.63, or an allowable range may be adjusted from 0.40-0.80 to 0.38-0.78. These values are illustrative and may be updated gradually according to a predetermined amount of feedback data, a statistical confidence condition, a time interval, or another implementation condition.

In some embodiments, user feedback may be processed both at a query level and at a domain-learning level. For example, when a user provides feedback indicating that charts are useful but that a more concise summary is needed, the system may use the feedback to adjust a response control parameter for a later query processing cycle. The Feedback Learning System (954) may also aggregate similar feedback patterns across sessions and use them to update financial-domain settings.

Through this example, the system may provide a financial-domain response by combining numerical data verification, semantic block analysis, verified static content integration, output template structuring, response-level quality verification, and multi-session feedback learning. The example may be implemented using the complete implementation configuration including the Common Service Layer (950) and the Feedback Learning System (954).

### Educational Content Implementation

In some embodiments, the system may be applied to an educational content response environment. This example may illustrate use of a query customization adjustment value for adapting a response to a learner level or an expression preference. For example, a user query may include a request such as “Explain the photosynthesis process for middle school students in an easy way.”

In this example, the system may identify an educational domain based on terms or context included in the user query. The User Query Input Unit (100) may detect a target learner level, such as “for middle school students,” and an expression preference, such as “in an easy way.” The User Query Input Unit (100) may generate a style vector representing query intent, writing style, response nature, or another query characteristic.

The Feature Analyzer (140) may generate a query customization adjustment value based on the detected learner level, expression preference, information-depth requirement, or another query-specific characteristic. For example, when the user query includes the expression “in an easy way,” the Feature Analyzer (140) may generate a query customization adjustment value that reduces emphasis on technical expression complexity and increases emphasis on understandability or friendliness.

In one example, the Adaptive Optimization Unit (600) may apply the query customization adjustment value to an educational-domain or learner-level base value of the content-expression balance control value (λ). For example, a middle-school-level base value may be adjusted from 0.40 to 0.35. These numerical values are exemplary and may be changed according to implementation requirements, learner classification, domain setting, or service policy.

In another example, when a user query includes an expression such as “explain in detail,” the Feature Analyzer (140) may generate a different query customization adjustment value corresponding to a greater information-depth requirement. In such a case, the content-expression balance control value (λ) may be adjusted in a direction that increases emphasis on information accuracy, conceptual completeness, or technical terminology.

The AI Response Generation Unit (200) may generate an initial response output for the user query. The Response Semantic Analysis Unit (300) may divide the initial response output into semantic blocks and evaluate information accuracy for one or more of the semantic blocks. For example, a semantic block describing that photosynthesis is a process by which plants use light energy to produce glucose from carbon dioxide and water may be evaluated as having relatively high information accuracy or intrinsic significance because it corresponds to a core concept definition.

The Output Purpose Determination Unit (400) may select an educational explanation template. In some embodiments, the educational explanation template may include sections such as concept definition, importance, step-by-step process, example, application, and review question. The Content Matching Unit (500) may identify verified static content related to photosynthesis, such as textbook-based explanations, diagrams, formulas, process tables, curriculum materials, or other educational reference materials.

The Output Structuring Unit (700) may arrange semantic blocks according to the selected educational explanation template. For example, concept definitions, principle explanations, step-by-step process descriptions, practical examples, and review questions may be arranged in a learning sequence. Verified static content, such as diagrams or process tables, may be integrated using inline insertion, reference-based connection, or separate-section presentation.

In some embodiments, learner-level settings may be used to determine an initial value or allowable range of the content-expression balance control value (λ). For example, elementary school, middle school, high school, college, or expert-level settings may use different base values or allowable ranges. These settings are exemplary and may be adjusted according to curriculum level, target learner group, subject matter, or implementation requirements.

The Response Quality Verification Unit (800) may generate internal feedback based on verified educational content. For example, the Internal Feedback Generator (820) may evaluate whether the response output maintains conceptual accuracy, learning sequence, readability, and audience suitability. The Adaptive Optimization Unit (600) may use the internal feedback to adjust the content-expression balance control value (λ) for a later query processing cycle.

In some embodiments, when external user feedback is provided, the system may combine the external feedback with internal feedback. For example, when a user indicates that a diagram is helpful but terminology is difficult, the system may adjust a response control parameter in a direction that maintains conceptual accuracy while reducing terminology difficulty or improving readability.

Through this example, the system may provide an educational-domain response by combining query-specific customization, learner-level adaptation, semantic block analysis, verified educational content integration, output template structuring, and feedback-based adjustment of the content-expression balance control value (λ).

### Electronic Engineering Implementation

In some embodiments, the system may be applied to an electronic engineering response environment. For example, a user query may include a request such as “Explain the temperature sensor interface method using a microcontroller.”

In this example, the system may identify an electronic engineering domain based on terms included in the user query, such as “microcontroller,” “temperature sensor,” “ADC,” “interface,” or another technical term. The User Query Input Unit (100) may analyze the query and generate a style vector representing query intent, writing style, response nature, or another query characteristic.

The Feature Analyzer (140) may detect that the user query requests an implementation-oriented explanation. For example, a phrase such as “interface method” may indicate a request for hardware configuration, signal flow, software implementation, or practical design information. Based on the detected query characteristics, the Feature Analyzer (140) may generate a query customization adjustment value.

In one example, the Adaptive Optimization Unit (600) may apply the query customization adjustment value to an electronic-engineering-domain base value of the content-expression balance control value (λ). For example, an electronic engineering base value may be adjusted from 0.70 to 0.67 and constrained within an allowable electronic-engineering-domain range, such as 0.45 to 0.80. These numerical values are exemplary and may be changed according to implementation requirements.

The AI Response Generation Unit (200) may generate an initial response output for the user query. The Response Semantic Analysis Unit (300) may divide the initial response output into semantic blocks and evaluate information accuracy for one or more semantic blocks. For example, semantic blocks describing circuit configuration, analog-to-digital conversion, interface protocol, signal conditioning, firmware processing, or code implementation may be evaluated based on technical accuracy, process clarity, or relevance to the requested implementation method.

The Output Purpose Determination Unit (400) may select an electronic engineering implementation template. In some embodiments, the template may include sections such as theoretical background, hardware configuration, interface method, software implementation, test method, troubleshooting, and practical application. The Content Matching Unit (500) may identify verified static content related to electronic engineering, such as datasheets, reference circuits, application notes, standard specifications, reference code, timing diagrams, pin configuration tables, or design guidelines.

The Output Structuring Unit (700) may integrate verified static content with one or more semantic blocks according to a content mapping table. For example, a circuit diagram, pin configuration table, timing diagram, ADC conversion formula, or reference code may be connected to corresponding semantic blocks through inline insertion, reference-based connection, or separate-section presentation.

In some embodiments, the system may supplement information that is absent or insufficient in the initially generated response output. For example, when an initially generated response output does not include sufficient information regarding signal conditioning, voltage range, ADC resolution, pull-up resistor configuration, decoupling, grounding, or firmware initialization, the system may connect verified static content corresponding to that topic and include the connected information in the final user-facing output.

The Response Quality Verification Unit (800) may generate internal feedback based on verified electronic engineering content. For example, the Internal Feedback Generator (820) may calculate an internal information accuracy feedback value (f_in_sem) and an internal expression style feedback value (f_in_style). In one example, f_in_sem may be 0.82 and f_in_style may be 0.75. These values are illustrative.

The Adaptive Optimization Unit (600) may adjust the content-expression balance control value (λ) based on the internal feedback. For example, a difference between f_in_sem and f_in_style may be used with the self-regulation mechanism described above. An adjusted value may be stored for use in a later query processing cycle rather than modifying the current response output.

In some embodiments, when external user feedback is provided, the system may combine the external feedback with internal feedback. For example, when a user indicates that a circuit diagram is useful but that a more detailed code explanation is needed for beginners, the system may generate external feedback values and combine them with internal feedback values using a feedback weighting value (φ).

For example, the system may derive f_out_sem and f_out_style from the external feedback and combine them with f_in_sem and f_in_style. The resulting combined feedback may be used to adjust the content-expression balance control value (λ) in a direction that maintains technical accuracy while increasing implementation detail or improving beginner-level readability. The numerical values and adjustment directions are illustrative and may vary according to domain settings, feedback weighting, and implementation requirements.

Through this example, the system may provide an electronic-engineering-domain response by combining implementation-oriented query analysis, semantic block evaluation, verified static content integration, output template structuring, internal feedback generation, and feedback-based adjustment of the content-expression balance control value (λ).

### INDUSTRIAL APPLICABILITY

In some embodiments, the disclosed system may be applied to various industrial, technical, and professional fields in which reliable, structured, and domain-appropriate artificial intelligence responses are required. The system may integrate user query analysis, response generation, semantic block analysis, output purpose classification, verified static content matching, adaptive optimization, response structuring, response quality verification, and final output provision.

In a medical field, the system may provide structured medical information, guidelines, health-related explanations, or other medical-domain responses adapted to different user types, such as patients, caregivers, or medical professionals. The system may arrange information according to a medical information structure, such as symptom, diagnosis, management principle, treatment information, precaution, or follow-up guidance, while integrating verified static content.

In an educational field, the system may generate learning content adapted to a learner level, subject matter, or requested explanation depth. For example, the system may provide core concepts, step-by-step explanations, examples, review questions, diagrams, or other educational materials in a structured format.

In legal and financial fields, the system may provide structured explanations of legal provisions, contract terms, financial products, market indicators, regulatory materials, or other professional information. For example, legal content may be organized according to a provision, interpretation, application, risk factor, or review point, and financial content may be organized according to market overview, key indicators, sector performance, risk factor, or outlook.

In a customer support field, the system may adjust response structure or expression level according to a user's technical understanding, issue type, or requested support level. For example, a response may be structured according to issue identification, cause analysis, solution, verification step, and follow-up guidance.

In a content generation or content verification field, the system may integrate dynamically generated response content with verified static content to support factual suitability, stylistic consistency, output structuring, and response quality evaluation.

The disclosed system may be implemented as software, hardware, firmware, a cloud-based service, an enterprise knowledge system, an embedded system, an application programming interface, or a combination thereof. The system may be applied to any domain in which generated response content is required to be evaluated, structured, supplemented, or substituted using verified static content.

In some embodiments, one or more operations described herein may be implemented as instructions stored on a non-transitory computer-readable storage medium. When executed by one or more processors, the instructions may cause the one or more processors to perform one or more operations of the methods described herein, including the method for structuring and outputting artificial intelligence responses to user queries.

What is claimed is:

1. A system for governing outputs of a generative artificial intelligence system, the system comprising:
one or more processors; and
one or more memories storing instructions that, when executed by the one or more processors, cause the system to:
generate, by a generative artificial intelligence model, a response output responsive to a user query;
calculate a response quality indicator representing a response-level quality of the response output;
determine, by comparing the response quality indicator with one or more predefined threshold values, whether the response output satisfies a response quality condition;
when the response quality condition is not satisfied, select, from a repository storing a plurality of pre-validated verified static content items in association with source information, at least one verified static content item based at least in part on a content relevance to the response output or the user query;
and form a final user-facing output in which at least a portion corresponding to the response output is formed using the at least one verified static content item,
wherein the final user-facing output is provided even when the response quality condition is not satisfied.

2. The system of claim 1, wherein, when the response quality condition is not satisfied, an alternative processing operation is performed in a differentiated manner according to a degree of deficiency determined from the comparison of the response quality indicator with the one or more predefined threshold values.

3. The system of claim 1, wherein the instructions further cause the system to divide the response output into a plurality of semantic blocks and to determine a block-level evaluation value for one or more of the plurality of semantic blocks, and wherein forming the at least a portion comprises replacing at least one deficient semantic block, identified based on the block-level evaluation value, with the at least one verified static content item, while at least one other semantic block of the plurality of semantic blocks contributes to the final user-facing output.

4. The system of claim 1, wherein the response quality indicator is calculated based on a weighted combination of a plurality of evaluation factors including an expressive characteristic and a content characteristic of the response output.

5. The system of claim 1, wherein the final user-facing output includes at least a portion of the source information associated with the at least one verified static content item.

6. The system of claim 1, wherein the instructions further cause the system to connect at least one additional verified static content item to the final user-facing output to supplement information that is absent or insufficient in the response output.

7. The system of claim 1, wherein the at least one verified static content item comprises at least one of a text, a table, a formula, a chart, an image, a guideline, or a reference material.

8. The system of claim 1, wherein the repository stores verified static content items of a medical domain, a legal domain, or a financial domain, and wherein the at least one verified static content item is selected further based on a domain associated with the user query.

9. The system of claim 8, wherein the verified static content items of the legal domain comprise a precedent summary or a statutory provision.

10. A system for governing outputs of a generative artificial intelligence system, the system comprising:
one or more processors; and
one or more memories storing instructions that, when executed by the one or more processors, cause the system to:
generate, by a generative artificial intelligence model, a response output responsive to a user query;
divide the response output into a plurality of semantic blocks;
determine a block-level evaluation value for at least one semantic block of the plurality of semantic blocks;
select, from a repository storing a plurality of pre-validated verified static content items in association with source information, at least one verified static content item related to the at least one semantic block;
determine, based at least in part on the block-level evaluation value, a connection method between the at least one semantic block and the at least one verified static content item, the connection method being determined from among a plurality of connection methods comprising an inline insertion, a reference-based connection, and a separate-section presentation;
generate a content mapping table representing connection information between the at least one semantic block and the at least one verified static content item, the connection information including at least the determined connection method and an insertion position;
and form a final user-facing output by integrating the at least one verified static content item with one or more of the plurality of semantic blocks according to the content mapping table,
wherein the final user-facing output includes the at least one verified static content item connected according to the determined connection method.

11. The system of claim 10, wherein the reference-based connection connects the at least one verified static content item to the at least one semantic block through a footnote-form indicator in the final user-facing output.

12. The system of claim 10, wherein determining the connection method comprises comparing the block-level evaluation value with one or more threshold values, such that a first range of the block-level evaluation value corresponds to the inline insertion, a second range corresponds to the reference-based connection, and a third range corresponds to the separate-section presentation.

13. The system of claim 10, wherein the block-level evaluation value comprises at least one of an information accuracy, a comprehensive evaluation index, or a content relevance associated with the at least one semantic block.

14. The system of claim 10, wherein the instructions further cause the system to determine, based on a response quality condition associated with the response output, whether the response output requires alternative processing prior to forming the final user-facing output.

15. The system of claim 14, wherein the alternative processing comprises preventing at least one deficient semantic block, identified based on the block-level evaluation value, from contributing to formation of the final user-facing output, and forming a corresponding portion of the final user-facing output using at least one of the pre-validated verified static content items.

16. The system of claim 10, wherein the connection information of the content mapping table further includes at least one of a connection priority or a conditional display rule.

17. The system of claim 10, wherein each verified static content item of the plurality of pre-validated verified static content items is uniquely identified in the repository by a content identifier and is managed together with the source information and a reliability indication.

18. The system of claim 10, wherein the final user-facing output includes at least a portion of the source information associated with the at least one verified static content item.

19. The system of claim 18, wherein the final user-facing output further includes traceability information indicating at least one of: a semantic block to which a verified static content item has been connected, the verified static content item used, the determined connection method, or a replacement or supplementation status.

20. The system of claim 10, wherein a precedent summary or a statutory provision of a legal domain is connected, as a verified static content item, to a semantic block of the response output through the reference-based connection.

21. A method for governing outputs of a generative artificial intelligence system, the method comprising:
generating, by a generative artificial intelligence model, a response output responsive to a user query;
calculating a response quality indicator representing a response-level quality of the response output;
determining, by comparing the response quality indicator with one or more predefined threshold values, that the response output does not satisfy a response quality condition;
in response to determining that the response output does not satisfy the response quality condition, selecting, from a repository storing a plurality of pre-validated verified static content items in association with source information, at least one verified static content item based at least in part on a content relevance to the response output or the user query;
and forming a final user-facing output in which at least a portion corresponding to the response output is formed using the at least one verified static content item,
wherein the final user-facing output is provided notwithstanding that the response output does not satisfy the response quality condition.

22. The method of claim 21, wherein an alternative processing operation is performed in a differentiated manner according to a degree of deficiency determined from the comparison of the response quality indicator with the one or more predefined threshold values.

23. The method of claim 21, wherein the final user-facing output includes at least a portion of the source information associated with the at least one verified static content item.

24. The method of claim 21, wherein the selecting comprises selecting at least one additional verified static content item to supplement information that is absent or insufficient in the response output.
